(19) United States
(12) Patent Application Publication
(10) Pub. No.: US 2021/0144038 A1
(43) Pub. Date: May 13, 2021

(54) CONTROL SIGNALING FOR DEMODULATION REFERENCE SIGNAL ANTENNA PORT INDICATION

(71) Applicant: Intel IP Corporation, Santa Clara, CA (US)

(72) Inventors: Alexei Davydov, Nizhny Novgorod (RU); Victor Sergeev, Nizhny Novgorod (RU); Seok Chul Kwon, Irvine, CA (US); Yushu Zhang, Beijing (CN); Avik Sengupta, San Jose, CA (US)

(73) Assignee: Intel IP Corporation, Santa Clara, CA (US)

(21) Appl. No.: 16/488,563

(22) PCT Filed: Mar. 23, 2018
(86) PCT No.: PCT/US18/24201

§ 371 Date: Aug. 23, 2019

Related U.S. Application Data
(60) Provisional application No. 62/476,567, filed on Mar. 24, 2017.
(60) Provisional application No. 62/545,235, filed on Aug. 14, 2017.
(60) Provisional application No. 62/587,929, filed on Nov. 17, 2017.

(51) Int. Cl. H04L 27/26; H04L 5/00; H04B 7/0452; H04W 72/04; H04W 76/27

(52) U.S. Cl. CPC H04L 27/2613; H04L 5/0048; H04W 76/27; H04W 72/042; H04L 5/0023; H04B 7/0452

(57) ABSTRACT

Described is an apparatus of an eNB operable to communicate with a UE on a wireless network. The apparatus may comprise a first circuitry, a second circuitry, a third circuitry, and a fourth circuitry. The first circuitry may be operable to process a first transmission carrying a DM-RS antenna port group indicator and a second transmission carrying an antenna port configuration indicator. The second circuitry may be operable to select a DM-RS antenna port group comprising a set of antenna port configurations based upon the DM-RS antenna port group indicator. The third circuitry may be operable to select an antenna port configuration out of the set of antenna port configurations based upon the antenna port configuration indicator, the antenna port configuration comprising one or more DM-RS antenna ports. The fourth circuitry may be operable to process a third transmission carrying DM-RS in accordance with the selected configuration.

### CLAIM OF PRIORITY

The present application claims priority under 35 U.S.C. § 119(e) to U.S. Provisional Patent Application Ser. No. 62/476,567 filed Mar. 24, 2017 and entitled “CONTROL SIGNALLING FOR DM-RS ANTENNA PORT INDICATION IN MU-MIMO,” to U.S. Provisional Patent Application Ser. No. 62/545,235 filed Aug. 14, 2017 and entitled “DEMODULATION REFERENCE SIGNAL INDICATION AND SIGNALING,” and to U.S. Provisional Patent Application Ser. No. 62/587,929 filed Nov. 17, 2017 and entitled “DEMODULATION REFERENCE SIGNAL (DM-RS) ANTENNA PORT INDICATION AND SIGNALING,” which are herein incorporated by reference in their entirety.

### BACKGROUND

A variety of wireless cellular communication systems have been implemented, including 3rd Generation Partnership Project (3GPP) Universal Mobile Telecommunications Systems (UMTS), 3GPP Long-Term Evolution (LTE) systems, and 3GPP LTE-Advanced (LTE-A) systems. Next-generation wireless cellular communication systems based upon LTE and LTE-A systems are being developed, such as Fifth Generation (5G) wireless systems/5G mobile networks systems. Next-generation wireless cellular communication systems may support beamforming through Multiple-Input Multiple-Output (MIMO) techniques, such as Single-User MIMO (SU-MIMO) techniques and/or Multi-User MIMO (MU-MIMO) techniques.

### BRIEF DESCRIPTION OF THE DRAWINGS

The embodiments of the disclosure will be understood more fully from the detailed description given below and from the accompanying drawings of various embodiments of the disclosure. However, while the drawings are to aid in explanation and understanding, they are only an aid, and should not be taken to limit the disclosure to the specific embodiments depicted therein.

FIG. 1 illustrates a scenario of Demodulation Reference Signal (DM-RS), in accordance with some embodiments of the disclosure.

FIG. 2 illustrates a flow diagram for configuration of DM-RS antenna port groups and DM-RS antenna ports, in accordance with some embodiments of the disclosure.

FIGS. 3A-3C illustrate scenarios of DM-RS patterns and Physical Downlink Shared Channel (PDSCH) multiplexing with DM-RS, in accordance with some embodiments of the disclosure.

FIG. 4 illustrates an Evolved Node-B (eNB and a User Equipment (UE), in accordance with some embodiments of the disclosure.

FIG. 5 illustrates hardware processing circuitries for a UE for supporting DM-RS port assignment to users and control signaling to notify users of DM-RS port assignments, in accordance with some embodiments of the disclosure.

FIG. 6 illustrates hardware processing circuitries for an eNB for supporting DM-RS port assignment to users and control signaling to notify users of DM-RS port assignments, in accordance with some embodiments of the disclosure.

FIG. 7 illustrates methods for a UE for supporting DM-RS port assignment to users and control signaling to notify users of DM-RS port assignments, in accordance with some embodiments of the disclosure.

FIG. 8 illustrates methods for an eNB for supporting DM-RS port assignment to users and control signaling to notify users of DM-RS port assignments, in accordance with some embodiments of the disclosure.

FIG. 9 illustrates example components of a device, in accordance with some embodiments of the disclosure.

FIG. 10 illustrates example interfaces of baseband circuitry, in accordance with some embodiments of the disclosure.

### DETAILED DESCRIPTION

Various wireless cellular communication systems have been implemented or are being proposed, including 3rd Generation Partnership Project (3GPP) Universal Mobile Telecommunications Systems (UMTS), 3GPP Long-Term Evolution (LTE) systems, 3GPP LTE-Advanced (LTE-A) systems, and 5th Generation (5G) wireless systems/5G mobile networks systems/5G New Radio (NR) systems.

Dual layer beamforming based transmission mode 9 (TM8) was introduced in LTE Release 9. In TM8, Physical Downlink Shared Channel (PDSCH) demodulation may be based on DM-RS. One DM-RS port may be precoded using a precoder associated with a PDSCH layer. For Multi-User Multiple-Input Multiple-Output (MU-MIMO), transparent MU-MIMO may be supported, since DM-RS overhead might not change with an increase of MU-MIMO transmission rank. In some embodiments, a maximum of four rank-one users may be served in one MU-MIMO transmission. In order to support four rank-one users with only two DM-RS ports (e.g., DM-RS ports 7/8), one additional Scrambling Identity (SCID) may be introduced (e.g., SCID=1). Thus, four rank-one users may use a {DM-RS, SCID} set which may correspond to {7/8, 0/1} (e.g., antenna ports {7/8, 0/1}) to generate DM-RS sequences. Since DM-RS with different SCID might not be orthogonal, an eNB may be disposed to using spatial precoding to mitigate an inter-user interference.

In LTE Release 10, TM9 extended a DM-RS structure of TM8 to support up to rank-eight Single-User Multiple-Input Multiple-Output (SU-MIMO) transmission. However, for MU-MIMO transmission, TM9 may simply keep the same MU-MIMO transmission order as TM8. Two DM-RS ports (e.g., {11, 13}) may be added to the same 12 Resource Elements (REs) associated with two DM-RS ports (e.g., {7, 8}) using length four Orthogonal Cover Code (OCC). A second group of 12 REs may be reserved for four other DM-RS ports (e.g., {9, 10, 12, 14}). When the transmission rank is greater than 2, both DM-RS groups are used.

FIG. 1 illustrates a scenario of Demodulation Reference Signal (DM-RS), in accordance with some embodiments of the disclosure. In a scenario 100, a first set of DM-RS ports (e.g., {7, 8, 11, 13}) may be carried in an RB at Orthogonal Frequency Division Multiplexing (OFDM) symbols 5, 6, 12, and 13, and at subcarrier frequencies 1, 6, and 11, while a second set of DM-RS ports (e.g., {9, 10, 12, 14}) may be carried in the RB at OFDM symbols 5, 6, 12, and 13, and at subcarrier frequencies 0, 5, and 10. FIG. 1 may correspond with DM-RS in transmission mode 9.

In various embodiments, DM-RS antenna ports which may be used for PDSCH transmission may be indicated in Downlink Control Information (DCI) Format 2C and/or DCI Format 2D using a 3-bit “Antenna port(s), scrambling identity, and number of layers indication” field, which may be decoded or otherwise interpreted in accordance with Table 1 below.

TABLE 1
Antenna port(s), scrambling identity
and number of layers indication table

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, n_{SCID} = 0 |
| 1 | 1 layer, port 7, n_{SCID} = 1 | 1 | 2 layers, ports 7-8, n_{SCID} = 1 |
| 2 | 1 layer, port 8, n_{SCID} = 0 | 2 | 3 layers, ports 7-9 |
| 3 | 1 layer, port 8, n_{SCID} = 1 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-14 |

5G systems and/or NR systems may support 12 orthogonal DM-RS antenna ports, which may in turn support higher order MU-MIMO with larger numbers of co-scheduled UEs. (Notably, the probability of using 12 or more DM-RS antenna ports at a Transmission/Reception Point (TRP) may not be particularly high, and may be advantageous primarily for a specific scenario of MU-MIMO transmission from a TRP with relatively large number of Transceiver Units (TXRUs) and in the presence of relatively high traffic loads.)

Support of DM-RS antenna port indication for a UE from a larger set of orthogonal DM-RS antenna ports (e.g., 12) may be related to provision in DCI of very large number bits. However, in many cases, not all of the DM-RS antenna port combinations supported in DCI may be used in practice. Thus, support of DM-RS antenna port indication may in some embodiments assume a maximum of 12 DM-RS antenna ports in MU-MIMO is not desirable, and an overhead reduction scheme in Downlink (DL) control signaling may be considered.

With respect to various embodiments, discussed herein are various approaches to reduce signaling overhead in DCI to indicate DM-RS antenna ports. In some embodiments, two or more DM-RS antenna port indication tables with different numbers of DM-RS antenna ports may be supported for MU-MIMO (e.g., 4 and 12). In some embodiments, DM-RS antenna port grouping may be supported, for which DM-RS antenna ports may be indicated to UEs from subsets of DM-RS antenna ports. Some embodiments may also support DM-RS antenna port grouping as discussed herein for DL transmission and/or Uplink (UL) transmission.

Various embodiments may support DM-RS for up to 12 antenna ports. In addition, two DM-RS configurations may be supported. A first configuration may support up to 4 orthogonal ports (e.g., 2 combs plus 2 cyclic shifts) with single-symbol DM-RS and up to 8 orthogonal ports (e.g., 2 combs plus 2 cyclic shifts plus 2 time domain Orthogonal Cover Code (OCC)) with two-symbol DM-RS. A second configuration may support up to 6 orthogonal ports (e.g., 3 combs plus 2 frequency domain OCC) with one-symbol DM-RS, and up to 12 orthogonal ports (e.g., 3 combs plus 2 frequency domain OCC plus 2 time domain OCC) with two symbol DM-RS.

With respect to various embodiments, discussed herein are mechanisms and methods for supporting DM-RS port assignment to users and control signaling to notify users of DM-RS port assignments. The proposed signaling, corresponding to various DM-RS indication tables, may also account for signaling to make a user aware of other co-scheduled users.

In some embodiments, for SU-MIMO operation, DM-RS ports may be assigned sequentially to a user on a first comb before moving to a second comb and/or a third comb. Data may then be multiplexed with DM-RS on empty combs. This may advantageously maximize data multiplexing opportunities during DM-RS transmission.

In some embodiments, for MU-MIMO operation, users configured with the highest number of layers may be first assigned to DM-RS ports. Users may be assigned to a first comb, and once the comb is filled, users may then be assigned to a next comb (e.g., a second comb). Data may then be multiplexed on empty combs. This may advantageously maximize data multiplexing while simultaneously reducing a number of entries in a DM-RS port indication table, which may therefore advantageously reduce control signaling overhead by using fewer bits to signal ports and other co-scheduled users.

With respect to various embodiments, DM-RS may be supported for up to 12 antenna ports. In addition, two DM-RS configurations may be supported. A first configuration may will support up to 4 orthogonal ports (e.g., 2 combs plus 2 cyclic shifts) with single-symbol DM-RS and up to 8 orthogonal ports (e.g., 2 combs plus 2 cyclic shifts plus 2 time domain OCC) with two-symbol DM-RS. A second configuration may support up to 6 orthogonal ports (e.g., 3 combs plus 2 frequency domain OCC) with one-symbol DM-RS and up to 12 orthogonal ports (3 combs plus 2 frequency domain OCC plus 2 time domain OCC) with two-symbol DM-RS.

NR may support multiplexing of DM-RS and data in the frequency domain for both DL and UL Cyclic Prefix OFDM (CP-OFDM) based DM-RS. In various embodiments, DM-RS indication may support MU-MIMO with up to 4 layers per user in the DL. In various embodiments, upper layer signaling might merely indicate a maximum number of DM-RS symbols, and the actual number of front-loaded DM-RS symbols may be dynamically indicated by DCI bits. NR may support implicit signaling of rate-matching in DM-RS symbols with no explicit DCI bits for such signaling.

Discussed herein are mechanisms and methods for supporting DM-RS port assignment to users and control signaling to notify users of DM-RS port assignments. Various embodiments may incorporate implicit signaling of PDSCH rate matching through a set of port assignment principles for data multiplexing in the frequency domain with the DM-RS. In some embodiments, various DM-RS indication tables may also support MU-MIMO by signaling each user with information of other co-scheduled ports, in addition to its own DM-RS port assignments. The DM-RS indication tables may allow for dynamic switching of an actual number of front loaded DM-RS symbols when applicable. In order to reduce DCI overhead, upper-layer signaling may advantageously reduce the number of DCI bits used for signaling under single user operation constraints.

In some embodiments, for SU-MIMO operation, DM-RS ports may be assigned sequentially to a user on a first frequency comb or Code Division Multiplexing (CDM) Group before moving to subsequent combs or CDM-Groups (e.g., a second comb or CDM-Group and/or a third comb or CDM-Group). Data may be multiplexed with DM-RS on one or more empty combs. This may advantageously maximize data multiplexing opportunities during DM-RS transmission, and may also implicitly signal for rate-matching (since data may be implicitly multiplexed on empty combs or CDM-Groups).

In some embodiments, for cases of MU-MIMO operation, users configured with the highest number of layers may be assigned first to DM-RS ports. Users may be assigned to the first CDM-Group and once all the ports within the CDM-Group are assigned, assignment may then move to the next CDM-Group. Data may be multiplexed on empty CDM-Groups, and users may be signaled with their assigned DM-RS ports as well as information about other co-scheduled ports or occupied CDM-Groups.

The mechanisms and methods for port assignment and signaling discussed herein may advantageously maximize data multiplexing while also implicitly handling signaling for rate-matching of data on DM-RS symbols (since data may be transmitted on empty CDM-Groups). Accordingly, the proposed method may reduce control signaling overhead, and may in turn employ fewer bits to signal DM-RS port assignment as well as other co-scheduled users and rate-matching for data multiplexing.

Also discussed herein are mechanisms and methods for Radio Resource Control (RRC) based higher layer signaling mechanisms, which may further reduce DCI signaling overhead in the case of SU-only operation by use of separate SU-only DM-RS antenna port indication tables, or through subset restriction and re-indexing of joint SU-MIMO and MU-MIMO DM-RS antenna port indication tables.

Accordingly, discussed herein may be designs of DM-RS antenna port indication tables supporting MU-MIMO operation in DL and UL, and RRC based signaling to reduce DCI overhead for SU operation.

In the following description, numerous details are discussed to provide a more thorough explanation of embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical, mechanical, or magnetic connection between the things that are connected, without any intermediary devices. The term “coupled” means either a direct electrical, mechanical, or magnetic connection between the things that are connected or an indirect connection through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking, or in any other manner.

It is to be understood that the terms so used are interchangeable under appropriate circumstances such that the embodiments of the invention described herein are, for example, capable of operation in other orientations than those illustrated or otherwise described herein.

The terms “left,” “right,” “front,” “back,” “top,” “bottom,” “over,” “under,” and the like in the description and in the claims, if any, are used for descriptive purposes and not necessarily for describing permanent relative positions.

For purposes of the embodiments, the transistors in various circuits, modules, and logic blocks are Tunneling FETs (TFETs). Some transistors of various embodiments may comprise metal oxide semiconductor (MOS) transistors, which include drain, source, gate, and bulk terminals. The transistors may also include Tri-Gate and FinFET transistors, Gate All Around Cylindrical Transistors, Square Wire, or Rectangular Ribbon Transistors or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors-BJT PNP/NPN, BiCMOS, CMOS, etc., may be used for some transistors without departing from the scope of the disclosure.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

In addition, for purposes of the present disclosure, the term “eNB” may refer to a legacy LTE capable Evolved Node-B (eNB), a next-generation or 5G capable eNB, an Access Point (AP), and/or another base station for a wireless communication system. The term “gNB” may refer to a 5G-capable or NR-capable eNB. For purposes of the present disclosure, the term “UE” may refer to a legacy LTE capable User Equipment (UE), a Station (STA), and/or another mobile equipment for a wireless communication system. The term “UE” may also refer to a next-generation or 5G capable UE.

Various embodiments of eNBs and/or UEs discussed below may process one or more transmissions of various types. Some processing of a transmission may comprise demodulating, decoding, detecting, parsing, and/or otherwise handling a transmission that has been received. In some embodiments, an eNB or UE processing a transmission may determine or recognize the transmission's type and/or a condition associated with the transmission. For some embodiments, an eNB or UE processing a transmission may act in accordance with the transmission's type, and/or may act conditionally based upon the transmission's type. An eNB or UE processing a transmission may also recognize one or more values or fields of data carried by the transmission. Processing a transmission may comprise moving the transmission through one or more layers of a protocol stack (which may be implemented in, e.g., hardware and/or software-configured elements), such as by moving a transmission that has been received by an eNB or a UE through one or more layers of a protocol stack.

Various embodiments of eNBs and/or UEs discussed below may also generate one or more transmissions of various types. Some generating of a transmission may comprise modulating, encoding, formatting, assembling, and/or otherwise handling a transmission that is to be transmitted. In some embodiments, an eNB or UE generating a transmission may establish the transmission's type and/or a condition associated with the transmission. For some embodiments, an eNB or UE generating a transmission may act in accordance with the transmission's type, and/or may act conditionally based upon the transmission's type. An eNB or UE generating a transmission may also determine one or more values or fields of data carried by the transmission. Generating a transmission may comprise moving the transmission through one or more layers of a protocol stack (which may be implemented in, e.g., hardware and/or software-configured elements), such as by moving a transmission to be sent by an eNB or a UE through one or more layers of a protocol stack.

In various embodiments, resources may span various Resource Blocks (RBs), Physical Resource Blocks (PRBs), and/or time periods (e.g., frames, subframes, and/or slots) of a wireless communication system. In some contexts, allocated resources (e.g., channels, Orthogonal Frequency-Division Multiplexing (OFDM) symbols, subcarrier frequencies, resource elements (REs), and/or portions thereof) may be formatted for (and prior to) transmission over a wireless communication link. In other contexts, allocated resources (e.g., channels, OFDM symbols, subcarrier frequencies, REs, and/or portions thereof) may be detected from (and subsequent to) reception over a wireless communication link.

With respect to various embodiments, in order to reduce the number of bits used DCI for DM-RS antenna port indication, multiple values of the total orthogonal DM-RS antenna ports in MU-MIMO may be considered. For example, NR may support a DM-RS antenna port indication table with N=4, N=8, and/or N=12 orthogonal DM-RS antenna ports for MU-MIMO. In some embodiments, the actual value of N may be indicated to a UE using higher-layer signaling. When a relatively smaller value of N is indicated to a UE, DCI may provide control channel transmission with reduced DCI signaling overhead. For some such embodiments, an UE may be also configured with N=O, in which case a DM-RS antenna port indication may merely support SU-MIMO, which may advantageously minimize DCI signaling overhead.

In some embodiments, one or more orthogonal DM-RS antenna ports supported by NR, up to and including all DM-RS antenna ports, may be subdivided into two or more DM-RS antenna port groups. For some embodiments, different groups of DM-RS antenna ports may comprise non-overlapping sets of DM-RS antenna ports (e.g., DM-RS antenna ports indices). For some embodiments, different groups of DM-RS antenna ports may comprise partially overlapping sets of DM-RS antenna ports (e.g., DM-RS antenna ports indices).

For example, a first group of DM-RS antenna ports may comprise DM-RS antenna ports 10-71, while a second group of DM-RS antenna ports may comprise DM-RS antenna ports {4-12}. In some embodiments, the number of DM-RS antenna ports in each group may be reduced from a relatively larger number to a relatively smaller number (e.g., from 12 to 8), which may advantageously reduce a number of bits used to indicate the various DM-RS antenna port indices to the UE.

In some embodiments, an actual DM-RS antenna port group from which one or more DM-RS antenna ports are indicated to the UE by using DCI may itself be indicated to a UE using RRC or Media Access Control (MAC) signaling. In some embodiments, a DM-RS antenna port group may be indicated to a UE in DCI transmitted with a lower duty cycle.

Notably, DM-RS antenna ports groups may also be used for scenarios with dynamic Time-Division Duplex (TDD) in which orthogonal multiplexing of DL DM-RS antenna ports and UL DM-RS antenna ports may be used to improve a channel estimation performance in the presence of cross-link interference (e.g., DL-to-UL, or UL-to-DL). To support such scenarios, orthogonal DM-RS antenna ports groups may be supported, in which each DM-RS antenna port group may be associated with either DL transmission to a UE or UL transmission from the UE. In multi-point scenarios, DM-RS antenna port grouping may also be supported, in which one or more DM-RS antenna port groups may be associated with different Transmission Points (TPs). An association of DM-RS antenna port groups with TPs may be made implicitly by association with certain reference signal (e.g., by association with Channel State Information Reference Signal (CSI-RS)) transmitted by the TP.

FIG. 2 illustrates a flow diagram for configuration of DM-RS antenna port groups and DM-RS antenna ports, in accordance with some embodiments of the disclosure. A process 200 may have a first portion, a second portion, and a third portion. In the first portion, a DM-RS antenna port group for MU-MIMO may be configured at a UE. In the second portion, an indicator of one or more DM-RS antenna port(s) from the configured DM-RS antenna port group may be transmitted in DCI. In the third part, a physical shared channel (e.g., PDSCH) may be transmitted on the indicated DM-RS antenna ports (e.g., on resources corresponding to the indicated DM-RS antenna ports).

With respect to various embodiments, higher layer signaling may be used to notify a user of a DM-RS configuration, and single-user or multi-user operation, with a variable N={0,1,4,6,8,12}. In some embodiments, SU-MIMO operation may be signaled by N={0,1}. In some embodiments, MU-MIMO operation may be signaled with N={4,6,8,12}, which may indicate a number of orthogonal ports. For SU-MIMO operation, it may be assumed that UE may be configured with a maximum of 8 layers. For MU-MIMO operation, it may be assumed that one or more UEs in the MU-MIMO mode (up to and including each UE in the MU-MIMO mode) may be configured with 2 layers.

FIGS. 3A-3C illustrate scenarios of DM-RS patterns and PDSCH multiplexing with DM-RS, in accordance with some embodiments of the disclosure. In a first scenario 310, a first configuration may comprise DM-RS multiplexed in a first comb and a second comb. In a second scenario 320, a second configuration may comprise DM-RS multiplexed in a first RE-Pair, a second RE-Pair, and a third RE-Pair.

In some embodiments, PDSCH (e.g., data) may be multiplexed with DM-RS, such as when the DM-RS and the PDSCH occupy different combs (e.g., in the case of the first DM-RS configuration) and different RE-Pairs (e.g., in the case of the second DM-RS configuration). For example, in a third scenario 330, a third configuration (which may be an example of PDSCH multiplexing on comb 2) may comprise PDSCH multiplexed with DM-RS.

To facilitate efficient PDSCH multiplexing with DM-RS, and to reduce a number of signaling entries in DM-RS antenna port indication tables, various of the following assignment rules for assigning DM-RS ports to UEs may be used.

For SU-MIMO operation, ports may be assigned sequentially on a first comb before moving to a second comb or RE-Pair (and subsequent combs or RE-Pairs, e.g. a third comb or RE-Pair), and PDSCH may be multiplexed on empty combs or RE-Pairs.

For MU-MIMO operation, UEs configured with highest number of layers may be assigned first. UEs may be assigned sequentially on the same comb or RE-Pair first before moving to other combs or RE-Pairs to facilitate PDSCH multiplexing on empty combs or RE-Pairs.

For example, in scenario 330, DM-RS may occupy a first comb while PDSCH may occupy a second comb. For MU-MIMO operation, a first comb or a first RE-Pair may be assigned first before assigning further combs or RE-Pairs (e.g., before assigning a second comb or RE-Pair, and before assigning a third comb or RE-Pair). This may advantageously reduce signaling to indicate PDSCH multiplexing (e.g., if indicating a port on a third comb or RE-Pair, and there is no possibility of having PDSCH multiplexing since combs/RE-Pairs 1 and 2 might be assumed to have been assigned to other users).

Port definitions for various configurations may correspond with Table 2 below:

TABLE 2
port definitions for various configurations

| | |
|---|---|
| Config 1: | Config 1: |
| one symbol | two symbol |
| N = 0, 4 | N = 0, 8 |

| Port | Comb | CS | Port | Comb | CS | TD-OCC |
|---|---|---|---|---|---|---|
| 7 | 1 | 1 | 7 | 1 | 1 | + + |
| 8 | 2 | 1 | 8 | 2 | 1 | + + |
| 9 | 1 | 2 | 9 | 1 | 2 | + + |
| 10 | 2 | 2 | 10 | 2 | 2 | + + |
| | | | 11 | 1 | 1 | + − |
| | | | 12 | 2 | 1 | + − |
| | | | 13 | 1 | 2 | + − |
| | | | 14 | 2 | 2 | + − |

| Config 2: | | | Config 2: | | | |
|---|---|---|---|---|---|---|
| one symbol | | | two symbol | | | |
| N = 1, 6 | | | N = 1, 12 | | | |
| Port | RE Pair | FD-OCC | Port | RE-Pair | FD-OCC | TD-OCC |
| 7 | 1 | + + | 7 | 1 | + + | + + |
| 8 | 2 | + + | 8 | 2 | + + | + + |
| 9 | 3 | + + | 9 | 3 | + + | + + |
| 10 | 1 | + − | 10 | 1 | + − | + + |
| 11 | 2 | + − | 11 | 2 | + − | + + |
| 12 | 3 | + − | 12 | 3 | + − | + + |
| | | | 13 | 1 | + + | + − |
| | | | 14 | 2 | + + | + − |
| | | | 15 | 3 | + + | + − |
| | | | 16 | 1 | + − | + − |
| | | | 17 | 2 | + − | + − |
| | | | 18 | 3 | + − | + − |

For SU-MIMO operation in a first configuration (e.g., configuration 310), for N=0, the port definitions may allow for a maximum of 4 orthogonal ports for the case of one-symbol DM-RS, and a maximum of 8 orthogonal ports for the case of two-symbol DM-RS, the DM-RS indication table may be as provided in Table 3 below. Note that for up to 4 layers, use of one-symbol DM-RS may be more efficient in terms of overhead.

TABLE 3
DM-RS Indication Table for N = 0
DM-RS Indication Table for N = 0

| | |
|---|---|
| Value | Meaning |

One CW (1-4 layers)

| | | |
|---|---|---|
| 0 | 1 layer, port 0 | C1: one symbol; Data on comb 2 |
| 1 | 2 layers, port 0, 2 | C1: one symbol, Data on comb 2 |
| 2 | 3 layers, port 0-2 | C1: one symbol, No data multiplexed |
| 3 | 4 layers, port 0-3 | C1: one symbol, No data multiplexed |

Two CW (5-8 layers)

| | | |
|---|---|---|
| 4 | 5 layers, port 0-4 | C1: two symbol, No data multiplexing |
| 5 | 6 layers, port 0-5 | C1: two symbol, No data multiplexing |
| 6 | 7 layers, port 0-6 | C1: two symbol, No data multiplexing |
| 7 | 8 layers, port 0-7 | C1: two symbol, No data multiplexing |

For SU-MIMO operation in a second configuration (e.g., configuration 320), for N=1, the DM-RS indication table may be as provided Table 4 below. As with the first configuration, the use of single-symbol DM-RS with no PDSCH multiplexing may be more efficient in terms of signaling overhead.

TABLE 4
DM-RS Indication Table for N = 1
DM-RS Indication Table for N = 1

| | |
|---|---|
| Value | Meaning |

One CW (1-4 layers)

| | | |
|---|---|---|
| 0 | 1 layer, port 0 | C2: one symbol; Data on RE-Pairs 2, 3 |
| 1 | 2 layers, port 0, 3 | C2: one symbol, Data on RE-Pairs 2, 3 |
| 2 | 3 layers, port 0, 1, 3 | C2: one symbol, Data on RE-Pair 3 |
| 3 | 4 layers, port 0, 1, 3, 4 | C2: one symbol, Data on RE-Pair 3 |

Two CW (5-8 layers)

| | | |
|---|---|---|
| 4 | 5 layers, port 0-4 | C2: one symbol, No data multiplexing |
| 5 | 6 layers, port 0-5 | C2: one symbol, No data multiplexing |
| 6 | 7 layers, port 0, 1, 3, 4, | C2: two symbol, Data on RE-Pair 3 |
| | 6, 7, 9 | |
| 7 | 8 layers, port 0, 1, 3, 4, | C2: two symbol, Data on RE-Pair 3 |
| | 6, 7, 9, 11 | |

For MU-MIMO operation, defined DM-RS indication tables may make use of a variable P_{SCHED}, which may indicate other co-scheduled ports, to signal to the UE the presence and/or absence of other co-scheduled UEs in MU-MIMO mode. Using p_{SCHED} and following various port assignment rules, the DM-RS indication table for the case of MU-MIMO operation with one-symbol DM-RS in configuration 1 with 4 orthogonal ports (e.g., N=4) may be as provided by Table 5 below. Note that MU-MIMO support may merely be up to 2 layers, and 3-4 layer operation may be reserved for SU-MIMO mode, which might not employ the signaling of co-scheduled ports p_{SCHED}. For the case of MU-MIMO operation with two-symbol DM-RS in configuration 1 with up to 8 orthogonal ports (e.g., for N=8), the DM-RS indication tables may be as provided in Table 6 below.

TABLE 5
DM-RS Indication Table for N = 4
DM-RS Indication Table for N = 4
One CW (4 max Layers)

| Value | Message |
|---|---|
| 0 | 1 layer, port 0 (p_{SCHED} = —) |
| 1 | 1 layer, port 0 (p_{SCHED} = 2) |
| 2 | 1 layer, port 0 (p_{SCHED} = 1, 2, 3) |
| 3 | 1 layer, port 1 (p_{SCHED} = 0, 2) |
| 4 | 1 layer, port 1 (p_{SCHED} = 0, 2, 3) |
| 5 | 1 layer, port 2 (p_{SCHED} = 0) |
| 6 | 1 layer, port 2 (p_{SCHED} = 0, 1, 3) |
| 8 | 1 layer, port 3 (p_{SCHED} = 0, 1, 2) |
| 9 | 2 layer, port 0, 2 (p_{SCHED} = 0) |
| 10 | 2 layer, port 0, 2 (p_{SCHED} = 1, 3) |
| 11 | 2 layer, port 1, 3 (p_{SCHED} = 0, 2) |
| 12 | 3 layer, port 0-2 |
| 13 | 4 layer, port 0-3 |

TABLE 6
DM-RS Indication Table for N = 8
DM-RS Indication Table for N = 8

| | |
|---|---|
| Value | Message |

One CW (1-4 Layers)

| | |
|---|---|
| 0 | 1 layer, port 0 (p_{SCHED} = —) |
| 1 | 1 layer, port 0 (p_{SCHED} = 2, 4, 6) |
| 2 | 1 layer, port 0 (p_{SCHED} = 2, 4, 6, 1, 3, 5, 7) |
| 3 | 1 layer, port 1 (p_{SCHED} = 0, 2, 4, 6) |
| 4 | 1 layer, port 1 (p_{SCHED} = 3, 5, 7, 0, 2, 4, 6) |
| 5 | 1 layer, port 2 (p_{SCHED} = 0) |
| 6 | 1 layer, port 2 (p_{SCHED} = 0, 4, 6) |
| 7 | 1 layer, port 2 (p_{SCHED} = 0, 4, 6, 1, 3, 5, 7) |
| 8 | 1 layer, port 3 (p_{SCHED} = 1, 0, 2, 4, 6) |
| 9 | 1 layer, port 3 (p_{SCHED} = 1, 5, 7, 0, 2, 4, 6) |
| 10 | 1 layer, port 4 (p_{SCHED} = 0, 2, 6) |
| 11 | 1 layer, port 4 (p_{SCHED} = 0, 2, 6, 1, 3, 5, 7) |
| 12 | 1 layer, port 5 (p_{SCHED} = 1, 3, 7, 0, 2, 4, 6) |
| 13 | 1 layer, port 6 (p_{SCHED} = 0, 2, 4) |
| 14 | 1 layer, port 6 (p_{SCHED} = 0, 2, 4, 1, 3, 5, 7) |
| 15 | 1 layer, port 7 (p_{SCHED} = 1, 3, 5, 0, 2, 4, 6 |
| 16 | 2 layer, port 0, 2 (p_{SCHED} = —) |
| 17 | 2 layer, port 0, 2 (p_{SCHED} = 4, 6) |
| 18 | 2 layer, port 0, 2 (p_{SCHED} = 4, 6, 1, 3, 5, 7) |
| 19 | 2 layer, port 4, 6 (p_{SCHED} = 0, 2) |
| 20 | 2 layer, port 4, 6 (p_{SCHED} = 0, 2, 1, 3, 5, 7) |
| 21 | 2 layer, port 1, 3 (p_{SCHED} = 0, 2, 4, 6) |
| 22 | 2 layer, port 1, 3 (p_{SCHED} = 5, 7, 0, 2, 4, 6) |
| 23 | 2 layer, port 5, 7 (p_{SCHED} = 0, 1, 2, 3, 4, 6) |
| 24 | 3 layer, port 0, 2, 4 |
| 25 | 4 layer, port 0, 2, 4, 6 |

Two CW (5-8 Layers)

| | |
|---|---|
| 26 | 5 layer, port 0-4 |
| 27 | 6 layer, port 0-5 |
| 28 | 7 layer, port 0-6 |
| 29 | 8 layer, port 0-7 |

For the case of MU-MIMO operation with one symbol DM-RS in the second configuration with a maximum of 6 orthogonal ports (e.g., for N=6), the DM-RS indication table may be as provided in Table 7. Note that following the assignment, the case of PDSCH multiplexing only on RE-Pair 2 (e.g., with DM-RS on RE-Pair 3) might not be possible and hence may be discarded from the table. Finally, for the case of MU-MIMO operation with two symbol DM-RS in the second configuration with a maximum of 12 orthogonal ports (e.g., for N=12), the DM-RS indication table may be as provided in Table 8 below.

TABLE 7
DM-RS Indication Table for N = 6
DM-RS Indication Table for N = 6

| | |
|---|---|
| Value | Message |

One CW (1-4 Layers)

| | |
|---|---|
| 0 | 1 layer, port 0, (p_{SCHED} = — ) |
| 1 | 1 layer, port 0, (p_{SCHED} = 3) |
| 2 | 1 layer, port 0, (p_{SCHED} = 1, 3, 4) |
| 3 | 1 layer, port 0 (p_{SCHED} = 1-5) |
| 4 | 1 layer, port 1 (p_{SCHED} = 0, 3) |
| 5 | 1 layer, port 1 (p_{SCHED} = 0, 3, 4) |
| 6 | 1 layer, port 1 (p_{SCHED} = 0, 2-5) |
| 7 | 1 layer, port 2 (p_{SCHED} = 0, 1, 3, 4) |
| 8 | 1 layer, port 2 (p_{SCHED} = 0, 1, 3, 4, 5) |
| 9 | 1 layer, port 3 (p_{SCHED} = 0) |
| 10 | 1 layer, port 3 (p_{SCHED} = 0, 1, 4) |
| 11 | 1 layer, port 3 (p_{SCHED} = 0, 1, 2, 4, 5) |
| 12 | 1 layer, port 4 (d_{SCHED} = 3, p_{SCHED} = 0, 1, 3) |
| 13 | 1 layer, port 4 (p_{SCHED} = 0, 1, 2, 3, 5) |
| 14 | 1 layer, port 5 (p_{SCHED} = 0-4) |
| 15 | 2 layer, port 0, 3 (p_{SCHED} = —) |
| 16 | 2 layer, port 0, 3 (p_{SCHED} = 1, 4) |
| 17 | 2 layer, port 0, 3 (p_{SCHED} = 1, 2, 4, 5) |
| 18 | 2 layer, port 1, 4 (p_{SCHED} = 0, 3) |
| 19 | 2 layer, port 1, 4 (p_{SCHED} = 0, 2, 3, 5) |
| 20 | 2 layer, port 2, 5 (p_{SCHED} = 0, 1, 3, 4) |
| 21 | 3 layer, port 0, 1, 3 |
| 22 | 4 layers, port 0, 1, 3, 4 |

Two CW (5-6 Layers)

| | |
|---|---|
| 23 | 5 layers port 0, 1 (CW0) 2-4 (CW1) |
| 24 | 6 layers port 0-2 (CW0) 3-5 (CW1) |

TABLE 8
DM-RS Indication Table for N = 12
DM-RS Indication Table for N = 12

| | |
|---|---|
| Value | Message |

One CW (1-4 Layers)

| | |
|---|---|
| 0 | 1 layer, port 0 (p_{SCHED} = —) |
| 1 | 1 layer, port 0 (p_{SCHED} = 3) |
| 2 | 1 layer, port 0 (p_{SCHED} = 3, 6) |
| 3 | 1 layer, port 0 (p_{SCHED} = 3, 6, 9) |
| 4 | 1 layer, port 0 (p_{SCHED} = 1, 3, 4, 6, 7, 9, 10) |
| 5 | 1 layer, port 0 (p_{SCHED} = 1-11) |
| 6 | 1 layer, port 1 (p_{SCHED} = 0, 3, 6, 9) |
| 7 | 1 layer, port 1 (p_{SCHED} = 0, 3, 4, 6, 9) |
| 8 | 1 layer, port 1 (p_{SCHED} = 0, 3, 4, 6, 7, 9) |
| 9 | 1 layer, port 1 (p_{SCHED} = 0, 3, 4, 6, 7, 9, 10) |
| 10 | 1 layer, port 1 (p_{SCHED} = 0, 2-11) |
| 11 | 1 layer, port 2 (p_{SCHED} = 0, 1, 3, 4, 6, 7, 9, 10) |
| 12 | 1 layer, port 2 (p_{SCHED} = 0, 1, 3, 4, 5, 6, 7, 9, 10) |
| 13 | 1 layer, port 2 (p_{SCHED} = 0, 1, 3, 4, 5, 6, 7, 8, 9, 10) |
| 14 | 1 layer, port 2 (p_{SCHED} = 0, 1, 3-11) |
| 15 | 1 layer, port 3 (p_{SCHED} = 0) |
| 16 | 1 layer, port 3 (p_{SCHED} = 0, 6) |
| 17 | 1 layer, port 3 (p_{SCHED} = 0, 6, 9) |
| 18 | 1 layer, port 3 (p_{SCHED} = 0, 1, 4, 6, 7, 9, 10) |
| 19 | 1 layer, port 3 (p_{SCHED} = 0-2, 4-11) |
| 20 | 1 layer, port 4 (p_{SCHED} = 0, 1, 3, 6, 9) |
| 21 | 1 layer, port 4 (p_{SCHED} = 0, 1, 3, 6, 7, 9) |
| 22 | 1 layer, port 4 (p_{SCHED} = 0, 1, 3, 6, 7, 9, 10) |
| 23 | 1 layer, port 4 (p_{SCHED} = 0-3, 5-11) |
| 24 | 1 layer, port 5 (p_{SCHED} = 0, 1, 2, 3, 4, 6, 7, 9, 10) |
| 25 | 1 layer, port 5 (p_{SCHED} = 0-4, 6-10) |
| 26 | 1 layer, port 5 (p_{SCHED} = 0-4, 6-11) |
| 27 | 1 layer, port 6 (p_{SCHED} = 0, 3) |
| 28 | 1 layer, port 6 (p_{SCHED} = 0, 3, 9) |
| 29 | 1 layer, port 6 (p_{SCHED} = 0, 1, 3, 4, 7, 9, 10) |
| 30 | 1 layer, port 6 (p_{SCHED} = 0-5, 7-11) |
| 31 | 1 layer, port 7 (p_{SCHED} = 0, 1, 3, 4, 6, 9) |
| 32 | 1 layer, port 7 (p_{SCHED} = 0, 1, 3, 4, 6, 9, 10) |
| 33 | 1 layer, port 7 (p_{SCHED} = 0-6, 8-10) |
| 34 | 1 layer, port 8 (p_{SCHED} = 0, 1, 9, 3, 4, 5, 6, 7, 9, 10) |
| 35 | 1 layer, port 8 (p_{SCHED} = 0-7, 9-11) |
| 36 | 1 layer, port 9 (p_{SCHED} = 0, 3, 6) |
| 37 | 1 layer, port 9 (p_{SCHED} = 0, 1, 3, 4, 6, 7, 10) |
| 38 | 1 layer, port 9 (p_{SCHED} = 0-8, 10, 11) |
| 39 | 1 layer, port 10 (p_{SCHED} = 0, 1, 3, 4, 6, 7, 9) |
| 40 | 1 layer, port 10 (p_{SCHED} = 0-9, 11) |
| 41 | 1 layer, port 11 (p_{SCHED} = 0-10) |
| 42 | 2 layer, port 0, 3 (p_{SCHED} = —) |
| 44 | 2 layer, port 0, 3 (p_{SCHED} = 6, 9) |
| 45 | 2 layer, port 0, 3 (p_{SCHED} = 1, 4, 6, 7, 9, 10) |
| 46 | 2 layer, port 0, 3 (p_{SCHED} = 1, 2, 4-11) |
| 47 | 2 layer, port 6, 9 (p_{SCHED} = 0, 3) |
| 48 | 2 layer, port 6, 9 (p_{SCHED} = 0, 1, 3, 4, 7, 10) |
| 49 | 2 layer, port 6, 9 (p_{SCHED} = 0-5, 7, 8, 10, 11) |
| 50 | 2 layer, port 1, 4 (p_{SCHED} = 0, 3, 6, 9) |
| 52 | 2 layer, port 1, 4 (p_{SCHED} = 0, 3, 6, 7, 9, 10) |
| 53 | 2 layer, port 1, 4 (p_{SCHED} = 0, 2, 3, 5-11) |
| 54 | 2 layer, port 7, 10 (p_{SCHED} = 0, 1, 3, 4, 6, 9) |
| 55 | 2 layer, port 7, 10 (p_{SCHED} = 0-6, 8, 9, 11) |
| 56 | 2 layer, port 2, 5 (p_{SCHED} = 0, 1, 3, 4, 6, 7, 9, 10) |
| 57 | 2 layer, port 2, 5 (p_{SCHED} = 0, 1, 3, 4, 6, 7, 8, 9, 10) |
| 58 | 2 layer, port 2, 5 (p_{SCHED} = 0, 1, 3, 4, 6, 7, 8-11) |
| 59 | 2 layer, port 8, 11 (p_{SCHED} = 0-7, 8-10) |
| 60 | 3 layers, port 0, 3, 6 |
| 61 | 4 layers, port 0, 3, 6, 9 |

Two CW (5-8 Layers)

| | |
|---|---|
| 62 | 5 layers, port 0, 1, 3, 6, 9 |
| 63 | 6 layers, port 0, 1, 3, 4, 6, 9 |
| 64 | 7 layers, port 0, 1, 3, 4, 6, 7, 9 |
| 65 | 8 layers, port 0, 1, 3, 4, 6, 7, 9, 10 |

With respect to various embodiments, a UE may be configured with a maximum of 8 layers in the DL and 4 layers in the UL for cases of SU-MIMO operation. For cases of MU-MIMO operation, one or more UEs (up to and including each UE) in the MU-MIMO mode may be configured with at most 4 layers in the DL.

Returning to FIGS. 3A-3C, first scenario 310 may indicate DM-RS patterns for a first configuration and second scenario 320 may indicate DM-RS patterns for a second configuration. In various embodiments, PDSCH and Physical Uplink Shared Channel (PUSCH) for CP-OFDM based UL may be multiplexed with DM-RS, and the DM-RS and the PDSCH and PUSCH may occupy different CDM Groups. The term “CDM-Groups” may refer to different frequency combs in the case of the first configuration (e.g., in first scenario 310) and different RE-Pairs in the case of the second configuration (e.g., in second scenario 320). The port definitions for various configurations are provided in the following tables. Table 9 provides DM-RS port mapping for the first configuration, and Table 10 provides DM-RS port mapping for the second configuration.

TABLE 9
DM-RS Port Mapping Table for Configuration 1

| Port | CDM-Group (Comb) | FD-OCC | | TD-OCC | |
|---|---|---|---|---|---|
| 0 (1000) | 1 | +1 | +1 | +1 | +1 |
| 1 (1001) | 1 | +1 | −1 | +1 | +1 |
| 2 (1002) | 2 | +1 | +1 | +1 | +1 |
| 3 (1003) | 2 | +1 | −1 | +1 | +1 |
| 4 (1004) | 1 | +1 | +1 | +1 | −1 |
| 5 (1005) | 1 | +1 | −1 | +1 | −1 |
| 6 (1006) | 2 | +1 | +1 | +1 | −1 |
| 7 (1007) | 2 | +1 | −1 | +1 | −1 |

TABLE 10
DM-RS Port Mapping Table for Configuration 2

| Port | CDM-Group (RE-Pair) | FD-OCC | | TD-OCC | |
|---|---|---|---|---|---|
| 0 (1000) | 1 | +1 | +1 | +1 | +1 |
| 1 (1001) | 1 | +1 | −1 | +1 | +1 |
| 2 (1002) | 2 | +1 | +1 | +1 | +1 |
| 3 (1003) | 2 | +1 | −1 | +1 | +1 |
| 4 (1004) | 3 | +1 | +1 | +1 | +1 |
| 5 (1005) | 3 | +1 | −1 | +1 | +1 |
| 6 (1006) | 1 | +1 | +1 | +1 | −1 |
| 7 (1007) | 1 | +1 | −1 | +1 | −1 |
| 8 (1008) | 2 | +1 | +1 | +1 | −1 |
| 9 (1009) | 2 | +1 | −1 | +1 | −1 |
| 10 (1010) | 3 | +1 | +1 | +1 | −1 |
| 11 (1011) | 3 | +1 | −1 | +1 | −1 |

In various embodiments, to support efficient PDSCH and/or PUSCH multiplexing with DM-RS, a general antenna port mapping and UE assignment framework may advantageously permit rate matching does not need to be explicitly signaled to the UE by DCI bits, and may additionally reduce the number of signaling entries in DM-RS antenna port indication tables. For example, between 4 and 6 bits in DCI may correspond to different DM-RS configurations for antenna port indication.

For SU-MIMO operation, ports may be assigned sequentially on a first CDM-Group (e.g., a comb or an RE-pair) before moving to the second CDM-Group (and third CDM-Group), so that PDSCH (or PUSCH, for CP-OFDM based UL) may be multiplexed on empty CDM-Groups.

For MU-MIMO operation, UEs configured with the highest number of layers may be assigned first. UEs may be assigned sequentially on the same CDM-Group first before moving to other CDM-Groups, which may advantageously facilitate multiplexing of PDSCH (or PUSCH, for CP-OFDM based UL) on empty CDM-Groups.

Co-scheduled ports and/or CDM-Groups may be signaled along with antenna port indications to UEs, which may advantageously enable support of MU-MIMO and may support implicit signaling of rate matching with multiplexing of PDSCH (or PUSCH for CP-OFDM based UL) on empty CDM-Group(s).

For Discrete Fourier Transform spread OFDM (DFT-s-OFDM) based UL, a similar principle may be used for supported DM-RS patterns, except that multiplexing of PUSCH might not be considered.

For example, in third scenario 330 of FIG. 3, DM-RS may occupy a first comb while PDSCH may occupy a second comb. In some embodiments, for MU-MIMO operation, the first comb may be assigned first before assigning the second comb. This may reduce signaling used to indicate PDSCH multiplexing and related rate-matching information. For example, if indicating a port on the second comb, there might be no possibility of having PDSCH multiplexing, since the first comb may already be assumed to have been assigned to other active users. This in conjunction with assigned ports, occupied CDM-Groups, and/or co-scheduled port information in the antenna port indication tables may permit no additional DCI signaling to be used rate-matching.

In some embodiments, for MU-MIMO operation, to define the DM-RS indication tables, various entries in the tables may be associated with the following information: assigned DM-RS port(s); co-scheduled DM-RS port(s) within a CDM-Group for MU-MIMO; actual numbers of front-loaded DM-RS symbols (which may advantageously facilitate dynamic switching between ½ symbol DM-RS when a maximum number of DM-RS symbols is semi-statically configured to be 2); and/or occupied CDM-Group (which may indicate implicitly that PDSCH/PUSCH may be transmitted in an empty CDM-Group, e.g., for implicit rate-matching indication).

The DM-RS port indication table for the case of MU-MIMO operation with a maximum DM-RS length of 1 symbol, as indicated by RRC signaling, is given in Table 1 below for the case of DM-RS Configuration type 1. Up to 2 layers per UE is supported for MU-MIMO operation.

TABLE 11
DM-RS Antenna Port Indication Table for Configuration 1 with 1 Symbol
One CW (4 max Layers): DL/UL

| | Message | | | |
|---|---|---|---|---|
| | Assigned | Co-scheduled | #DM-RS | CDM Group |
| Value | Ports | Ports | Symbols | Occupancy |
| 0 | 1 layer, port 0 | — | 1 | 1 |
| 1 | 1 layer, port 0 | 1 | 1 | 1 |
| 2 | 1 layer, port 0 | 1-3 | 1 | 1, 2 |
| 3 | 1 layer, port 1 | 0, 2 | 1 | 1, 2 |
| 4 | 1 layer, port 1 | 0, 2, 3 | 1 | 1, 2 |
| 5 | 1 layer, port 2 | 0, 1 | 1 | 1, 2 |
| 6 | 1 layer, port 2 | 0, 1, 3 | 1 | 1, 2 |
| 7 | 1 layer, port 3 | 0-2 | 1 | 1, 2 |
| 8 | 2 layer, port 0, 1 | — | 1 | 1 |
| 9 | 2 layer, port 0, 1 | 2, 3 | 1 | 1, 2 |
| 10 | 2 layer, port 2, 3 | 0, 1 | 1 | 1, 2 |
| 11 | 3 layer, port 0-2 | — | 1 | 1, 2 |
| 12 | 4 layer, port 0-3 | — | 1 | 1, 2 |

The table may correspond with a DCI signaling overhead of 4 bits. For CP-OFDM based UL operation, the corresponding DM-RS antenna port indication table may be identical. For the case of DFT-s-OFDM, a second comb structure similar to Type 1 DM-RS (e.g., the first configuration) may be supported, and therefore an identical table may be used. In this case rate-matching might not be required, since multiplexing of PUSCH and DM-RS might not be supported.

The DM-RS port indication table for the case of MU-MIMO operation with a maximum DM-RS length of two symbols, as indicated by RRC signaling, is given in Table 12 for the case of DM-RS Configuration type 1. In some embodiments, up to 4 layers per UE is supported for MU-MIMO operation.

TABLE 12
DM-RS Antenna Port Indication Table for
Configuration 1 with At Most 2 Symbols

| | Message | | | |
|---|---|---|---|---|
| | Assigned | Co-scheduled | #DM-RS | CDM-Group |
| Value | Ports | Ports | Symbols | Occupancy |

One CW (1-4 Layers per UE): DL/UL

| | | | | |
|---|---|---|---|---|
| 0 | 1 layer, port 0 | — | 1 | 1 |
| 1 | 1 layer, port 0 | 1, 2, 3 | 1 | 1, 2 |
| 2 | 1 layer, port 0 | 1, 4, 5 | 2 | 1 |
| 3 | 1 layer, port 0 | 1-7 | 2 | 1, 2 |
| 4 | 1 layer, port 1 | 0 | 1 | 1 |
| 5 | 1 layer, port 1 | 0, 4, 5 | 2 | 1 |
| 6 | 1 layer, port 1 | 0, 2-7 | 2 | 1, 2 |
| 7 | 1 layer, port 2 | 0, 1, 3 | 1 | 1, 2 |
| 8 | 1 layer, port 2 | 0, 1, 3-7 | 2 | 1, 2 |
| 9 | 1 layer, port 3 | 0-2 | 1 | 1, 2 |
| 10 | 1 layer, port 3 | 0-2, 4-7 | 2 | 1, 2 |
| 11 | 1 layer, port 4 | 0, 1, 5 | 2 | 1 |
| 12 | 1 layer, port 4 | 0-3, 5-7 | 2 | 1, 2 |
| 13 | 1 layer, port 5 | 0, 1, 4 | 2 | 1 |
| 14 | 1 layer, port 5 | 0-4, 6, 7 | 2 | 1, 2 |
| 15 | 1 layer, port 6 | 0-5, 7 | 2 | 1, 2 |
| 16 | 1 layer, port 7 | 0-6 | 2 | 1, 2 |
| 17 | 2 layer, port 0, 1 | — | 1 | 1 |
| 18 | 2 layer, port 0, 1 | 4, 5 | 2 | 1 |
| 19 | 2 layer, port 0, 1 | 2-7 | 2 | 1, 2 |
| 20 | 2 layer, port 2, 3 | 0, 1 | 1 | 1, 2 |
| 21 | 2 layer, port 2, 3 | 0, 1, 4-7 | 2 | 1, 2 |
| 22 | 2 layer, port 4, 5 | 0, 1 | 2 | 1 |
| 23 | 2 layer, port 4, 5 | 0-3, 6, 7 | 2 | 1, 2 |
| 24 | 2 layer, port 6, 7 | 0-5 | 2 | 1, 2 |
| 25 | 3 layer, port 0-2 | — | 1 | 1, 2 |
| 26 | 3 layer, port 0, 1, 4 | 5 | 2 | 1 |
| 27 | 3 layer, port 0, 1, 4 | 2, 3, 5-7 | 2 | 1, 2 |
| 28 | 3 layer, port 2, 3, 5 | 0, 1, 4, 6, 7 | 2 | 1, 2 |
| 29 | 4 layer, port 0-3 | — | 1 | 1, 2 |
| 30 | 4 layer, port 0, 1, 4, 5 | 2, 3, 6, 7 | 2 | 1, 2 |
| 31 | 4 layer, port 2, 3, 6, 7 | 0, 1, 4, 5 | 2 | 1, 2 |

Two CW (5-8 Layers per UE): DL Only

| | | | |
|---|---|---|---|
| 32 | 5 layer, port 0-4 | 2 | 1, 2 |
| 33 | 6 layer, port 0-5 | 2 | 1, 2 |
| 34 | 7 layer, port 0-6 | 2 | 1, 2 |
| 35 | 8 layer, port 0-7 | 2 | 1, 2 |

| | |
|---|---|
| 36-63 | Reserved |

The table has a DCI signaling overhead of 6 bits. UL operation may encompass values 0-31 with a DCI overhead of 5 bits. Table 11 may support SU-MIMO signaling with a sub-set of values (e.g., {0, 8, 11, and 12} for DL and UL). Table 12 may support SU-MIMO signaling with a sub-set of values (e.g., {0, 17, 25, and 29} for UL and {0, 17, 25, 29, and 32-35} for DL. Table 12 may also facilitate dynamic switching between one-symbol and two-symbol DM-RS.

The DM-RS port indication table for the case of MU-MIMO operation with a maximum DM-RS length of 1 symbol, as indicated by RRC signaling, is provided in Table 13 below for DM-RS Configuration type 2. In some embodiments, up to 4 layers per UE may be supported for MU-MIMO operation.

TABLE 13
DM-RS Antenna Port Indication Table
for Configuration 2 with 1 Symbol

| | Message | | | |
|---|---|---|---|---|
| | Assigned | Co-scheduled | #DM-RS | CDM-Group |
| Value | Ports | Port | Symbols | Occupancy |

One CW (1-4 Layers): DL/UL

| | | | | |
|---|---|---|---|---|
| 0 | 1 layer, port 0 | — | 1 | 1 |
| 1 | 1 layer, port 0 | 1 | 1 | 1 |
| 2 | 1 layer, port 0 | 1-3 | 1 | 1, 2 |
| 3 | 1 layer, port 0 | 1-5 | 1 | 1, 2, 3 |
| 4 | 1 layer, port 1 | 0 | 1 | 1 |
| 5 | 1 layer, port 1 | 0, 2, 3 | 1 | 1, 2 |
| 6 | 1 layer, port 1 | 0, 2-5 | 1 | 1, 2, 3 |
| 7 | 1 layer, port 2 | 0, 1, 3 | 1 | 1, 2 |
| 8 | 1 layer, port 2 | 0, 1, 3-5 | 1 | 1, 2, 3 |
| 9 | 1 layer, port 3 | 0-2 | 1 | 1, 2 |
| 10 | 1 layer, port 3 | 0-2, 4, 5 | 1 | 1, 2, 3 |
| 11 | 1 layer, port 4 | 0-3 | 1 | 1, 2, 3 |
| 12 | 1 layer, port 4 | 0-3, 5 | 1 | 1, 2, 3 |
| 13 | 1 layer, port 5 | 0-4 | 1 | 1, 2, 3 |
| 14 | 2 layer, port 0, 1 | — | 1 | 1 |
| 15 | 2 layer, port 0, 1 | 2, 3 | 1 | 1, 2 |
| 16 | 2 layer, port 0, 1 | 2-5 | 1 | 1, 2, 3 |
| 17 | 2 layer, port 2, 3 | 0, 1 | 1 | 1, 2 |
| 18 | 2 layer, port 2, 3 | 0, 1, 4, 5 | 1 | 1, 2, 3 |
| 19 | 2 layer, port 4, 5 | 0-3 | 1 | 1, 2, 3 |
| 20 | 3 layer, port 0, 1, 2 | 3 | 1 | 1, 2 |
| 21 | 3 layer, port 0, 1, 2 | 3-5 | 1 | 1, 2, 3 |
| 22 | 3 layer, port 3, 4, 5 | 0-2 | 1 | 1, 2, 3 |
| 23 | 4 layers, port 0, 1, 2, 3 | — | 1 | 1, 2 |
| 24 | 4 layers, port 0, 1, 2, 3 | 4, 5 | 1 | 1, 2, 3 |

Two CW (5-8 Layers): DL Only

| | | | | |
|---|---|---|---|---|
| 25 | 5 layers port 0-4 | — | 1 | 1, 2, 3 |
| 26 | 6 layers port 0-5 | — | 1 | 1, 2, 3 |

| | |
|---|---|
| 27-31 | Reserved |

The table may correspond with a DCI signaling overhead of 5 bits. UL operation may encompass values 0-25, with a DCI overhead of 5 bits.

The DM-RS port indication table for the case of MU-MIMO operation with a maximum DM-RS length of two symbols, as indicated by RRC signaling, is given in Table 14 below for DM-RS Configuration type 2. In some embodiments, up to 4 layers per UE may be supported for MU-MIMO operation.

TABLE 14
DM-RS Antenna Port Indication Table for
Configuration 2 with At Most 2 Symbols

| | Message | | | |
|---|---|---|---|---|
| | Assigned | Co-scheduled | #DM-RS | CDM-Group |
| Value | Ports | Ports | Symbols | Occupancy |

One CW (1-4 Layers): DL/UL

| | | | | |
|---|---|---|---|---|
| 0 | 1 layer, port 0 | 1 | 1 | 1 |
| 1 | 1 layer, port 0 | 1, 6, 7 | 2 | 1 |
| 2 | 1 layer, port 0 | 1-3, 6-9 | 2 | 1, 2 |
| 3 | 1 layer, port 0 | 1-11 | 2 | 1, 2, 3 |
| 4 | 1 layer, port 1 | 0 | 1 | 1 |
| 5 | 1 layer, port 1 | 0, 2, 3 | 1 | 1, 2 |
| 6 | 1 layer, port 1 | 0, 2-5 | 1 | 1, 2, 3 |
| 7 | 1 layer, port 1 | 0, 6, 7 | 2 | 1 |
| 8 | 1 layer, port 1 | 2, 3, 6-9 | 2 | 1, 2 |
| 9 | 1 layer, port 1 | 0, 2-11 | 2 | 1, 2, 3 |
| 10 | 1 layer, port 2 | 0, 1, 3 | 1 | 1, 2 |
| 11 | 1 layer, port 2 | 0, 1, 3-5 | 1 | 1, 2, 3 |
| 12 | 1 layer, port 2 | 0, 1, 6, 7 | 2 | 1, 2 |
| 13 | 1 layer, port 2 | 0, 1, 6, 7, | 2 | 1, 2 |
| | | 3, 8, 9 | | |
| 14 | 1 layer, port 2 | 0, 3-11 | 2 | 1, 2, 3 |
| 15 | 1 layer, port 3 | 0-2 | 1 | 1, 2 |
| 16 | 1 layer, port 3 | 0-2, 4, 5 | 1 | 1, 2, 3 |
| 17 | 1 layer, port 3 | 0-2, 6-9 | 2 | 1, 2 |
| 18 | 1 layer, port 3 | 0-2, 4-11 | 2 | 1, 2, 3 |
| 19 | 1 layer, port 4 | 0-3, 5 | 1 | 1, 2, 3 |
| 20 | 1 layer, port 4 | 0-3, 5-11 | 2 | 1, 2, 3 |
| 21 | 1 layer, port 5 | 0-4 | 1 | 1, 2, 3 |
| 22 | 1 layer, port 5 | 0-4, 6-11 | 2 | 1, 2, 3 |
| 23 | 1 layer, port 6 | 0, 1, 7 | 2 | 1 |
| 24 | 1 layer, port 6 | 0-3, 7-9 | 2 | 1, 2 |
| 25 | 1 layer, port 6 | 0-5, 7-11 | 2 | 1, 2, 3 |
| 26 | 1 layer, port 7 | 0, 1, 6 | 2 | 1 |
| 27 | 1 layer, port 7 | 0-3, 6, 8, 9 | 2 | 1, 2 |
| 28 | 1 layer, port 7 | 0-6, 8-11 | 2 | 1, 2, 3 |
| 29 | 1 layer, port 8 | 0-3, 6, 7, 9 | 2 | 1, 2 |
| 30 | 1 layer, port 8 | 0-7, 9-11 | 2 | 1, 2, 3 |
| 31 | 1 layer, port 9 | 0-3, 6-8 | 2 | 1, 2 |
| 32 | 1 layer, port 9 | 0-8, 10, 11 | 2 | 1, 2, 3 |
| 33 | 1 layer, port 10 | 0-9, 11 | 2 | 1, 2, 3 |
| 34 | 1 layer, port 11 | 0-10 | 2 | 1, 2, 3 |
| 35 | 2 layer, port 0, 1 | — | 1 | 1 |
| 36 | 2 layer, port 0, 1 | 2, 3 | 1 | 1, 2 |
| 37 | 2 layer, port 0, 1 | 2-5 | 1 | 1, 2, 3 |
| 38 | 2 layer, port 0, 1 | 6, 7 | 2 | 1 |
| 39 | 2 layer, port 0, 1 | 2, 3, 6-9 | 2 | 1, 2 |
| 40 | 2 layer, port 0, 1 | 2-11 | 2 | 1, 2, 3 |
| 41 | 2 layer, port 2, 3 | 0, 1 | 1 | 1, 2 |
| 42 | 2 layer, port 2, 3 | 0, 1, 4, 5 | 1 | 1, 2, 3 |
| 43 | 2 layer, port 2, 3 | 0, 1, 6-9 | 2 | 1, 2 |
| 44 | 2 layer, port 2, 3 | 0, 1, 4-11 | 2 | 1, 2, 3 |
| 45 | 2 layer, port 4, 5 | 0-3 | 1 | 1, 2, 3 |
| 46 | 2 layer, port 4, 5 | 0-3, 6-11 | 2 | 1, 2, 3 |
| 47 | 2 layer, port 6, 7 | 0, 1 | 2 | 1 |
| 48 | 2 layer, port 6, 7 | 0-5, 8-11 | 2 | 1, 2, 3 |
| 49 | 2 layer, port 8, 9 | 0-7, 10, 11 | 2 | 1, 2, 3 |
| 50 | 2 layer, port 10, 11 | 0-9 | 2 | 1, 2, 3 |
| 51 | 3 layers, port 0, 1, 6 | 7 | 2 | 1 |
| 52 | 3 layers, port 0, 1, 6 | 2-5, 7-11 | 2 | 1, 2, 3 |
| 53 | 3 layers, port 2, 3, 7 | 0, 1, 4-6, 8-11 | 2 | 1, 2, 3 |
| 54 | 3 layers, port 4, 8, 9 | 0-3, 5-7, 10, 11 | 2 | 1, 2, 3 |
| 55 | 3 layers, port 5, 10, 11 | 0-4, 6-9 | 2 | 1, 2, 3 |
| 56 | 4 layers, port 0, 1, 6, 7 | — | 2 | 1 |
| 57 | 4 layers, port 0, 1, 6, 7 | 2-5, 8-11 | 2 | 1, 2, 3 |
| 58 | 4 layers, port 2, 3, 8, 9 | 0, 1, 4, 5, 8-11 | 2 | 1, 2, 3 |
| 59 | 4 layers, port 4, 5, 10, | 0-3, 6-9 | 2 | 1, 2, 3 |
| | 11 | | | |

Two CW (5-8 Layers): DL Only

| | | | | |
|---|---|---|---|---|
| 60 | 5 layers, port 0, 1, 2, | — | 2 | 1, 2 |
| | 6, 7 | | | |
| 61 | 6 layers, port 0-3, 6, 7 | — | 2 | 1, 2 |
| 62 | 7 layers, port 0-3, 6-8 | — | 2 | 1, 2 |
| 63 | 8 layers, port 0-3, 6-9 | — | 2 | 1, 2 |

The table may correspond with a DCI signaling overhead of 6 bits. UL operation may encompass values 0-59, with a DCI overhead of 6 bits. Table 13 may support SU-MIMO signaling with a sub-set of values (e.g., {0, 14, 20, and 23} for UL and {0, 14, 20, 23, 25, and 26} for the DL). Table 14 may support SU-MIMO signaling with a sub-set of values (e.g., {0, 35, 51, and 56} for UL and {0, 35, 51, 56, and 60-63} for DL). Table 14 may also facilitate dynamic switching between one-symbol DM-RS and two-symbol DM-RS.

To decrease a DCI overhead associated with SU-MIMO operation while using DCI signaling to indicate values from tables that support both SU and MU operation (as in Tables 11 through 14), higher layer RRC signaling may be employed.

In some embodiments, RRC signaling may semi-statically configure separate DCI antenna port indication tables for SU-MIMO operation for each of DM-RS configuration type 1 and DM-RS configuration type 2.

The DM-RS antenna port indication table for DL and/or UL SU-MIMO operation with DM-RS configuration type 1 may be as provided by Table 15 below.

TABLE 15
DM-RS Antenna Port Indication Table
for SU-MIMO with Type 1 DM-RS

| | |
|---|---|
| Value | Meaning |

One CW (1-4 layers): DL/UL

| | |
|---|---|
| 1 layer, port 0 | one symbol; Data on CDM-Group 2 |
| 2 layers, port 0, 1 | one symbol, Data on comb 2 |
| 3 layers, port 0-2 | one symbol, No data multiplexed |
| 4 layers, port 0-3 | one symbol, No data multiplexed |

Two CW (5-8 layers): DL Only

| | |
|---|---|
| 5 layers, port 0-4 | two symbol, No data multiplexing |
| 6 layers, port 0-5 | two symbol, No data multiplexing |
| 7 layers, port 0-6 | two symbol, No data multiplexing |
| 8 layers, port 0-7 | two symbol, No data multiplexing |

For UL SU-MIMO operation, a sub-set of the table (e.g., values 0-3) may correspond with a maximum of 4 layers at the UE to be used for antenna port indication. When a maximum DM-RS length is configured as one (e.g., via RRC), values 0-3 may be used for both DL and UL.

The DM-RS antenna port indication tables for SU-MIMO operation with DM-RS configuration 2 may be as presented in Table 16 below.

TABLE 16
DM-RS Antenna Port Indication
Table SU-MIMO with Type 2 DM-RS

| | |
|---|---|
| Value | Meaning |

One CW (1-4 layers): DL/UL

| | | |
|---|---|---|
| 0 | 1 layer, port 0 | one symbol; Data on RE-Pairs 2, 3 |
| 1 | 2 layers, port 0, 1 | one symbol, Data on RE-Pairs 2, 3 |
| 2 | 3 layers, port 0-2 | one symbol, Data on RE-Pair 3 |
| 3 | 4 layers, port 0-3 | one symbol, Data on RE-Pair 3 |

Two CW (5-8 layers): DL Only

| | | |
|---|---|---|
| 4 | 5 layers, port 0-4 | one symbol, No data multiplexing |
| 5 | 6 layers, port 0-5 | one symbol, No data multiplexing |
| 6 | 7 layers, port 0-3, 6, 7 | two symbol, Data on RE-Pair 3 |
| 7 | 8 layers, port 0-3, 6-9 | two symbol, Data on RE-Pair 3 |

For UL SU-MIMO operation, a sub-set of the table (e.g., values 0-3) corresponding to a maximum of 4 layers at a UE are used for antenna port indication. When a maximum DM-RS length is configured as one (e.g., via RRC signaling), values 0-5 may be used for DL, and values 0-3 may be used for UL.

In some embodiments, RRC signaling may be used to restrict entries of MU-MIMO based DM-RS antenna port indication tables such that merely a small subset of the values are indexed by DCI for SU-only operation.

For some embodiments, Tables 11 through 14 may be re-indexed such that the SU-MIMO values may be listed as the first values in the table. The use of the RRC signaling may then index these first values (for example, the first 8 values, or the first 4 values) values for DL (or UL) operation.

In some embodiments, subset restriction may implicitly index the values for each table as follows:

For Table 11 (e.g., DM-RS Type 1 max 1 symbol): For both DL and UL, with RRC based subset restriction, SU-MIMO-only operation with subset values (e.g., {0, 8, 11, and 12}) may be indicated by using a bit-map of size 2 bits.

For Table 12 (e.g., DM-RS Type 1 max 2 symbols): with RRC based subset restriction, SU-MIMO-only operation may be signaled for the case of DL with values {0, 17, 25, 29, 33-36}, which may be indexed by a bit-map of size 3 bits, and/or for the case of UL with values {0, 17, 25, 29}, which may be indexed with a bitmap of size 2 bits.

For Table 13 (e.g., DM-RS Type 2 max 1 symbol): with RRC based subset restriction, SU-MIMO-only operation may be signaled for the case of DL with values {0, 14, 20, 23, 25, and 26}, which may be indexed by a bit-map of size 3 bits, and/or for the case of UL with values {0, 14, 21 and 24}, which may be indexed with a bitmap of size 2 bits.

For Table 14 (e.g., DM-RS Type 2 max 2 symbols): with RRC based subset restriction, SU-MIMO-only operation may be signaled for the case of DL with values {0, 35, 51, 56, and 60-63}, which may be indexed by a bit-map of size 3 bits, and for the case of UL with values {0, 35, 51, and 56} which may be indexed with a bitmap of size 2 bits.

For some embodiments, RRC configuration signaling used for configuration of SU-MIMO or MU-MIMO operation may also be used to select one of two Precoding Resource Block Group (PRG) values. A first value may be chosen when SU-MIMO is configured (e.g., no other co-scheduled DM-RS ports are present), and a second value may be chosen when MU-MIMO is configured (e.g., when other co-scheduled DM-RS ports are present).

FIG. 4 illustrates an eNB and a UE, in accordance with some embodiments of the disclosure. FIG. 4 includes block diagrams of an eNB 410 and a UE 430 which are operable to co-exist with each other and other elements of an LTE network. High-level, simplified architectures of eNB 410 and UE 430 are described so as not to obscure the embodiments. It should be noted that in some embodiments, eNB 410 may be a stationary non-mobile device.

eNB 410 is coupled to one or more antennas 405, and UE 430 is similarly coupled to one or more antennas 425. However, in some embodiments, eNB 410 may incorporate or comprise antennas 405, and UE 430 in various embodiments may incorporate or comprise antennas 425.

In some embodiments, antennas 405 and/or antennas 425 may comprise one or more directional or omni-directional antennas, including monopole antennas, dipole antennas, loop antennas, patch antennas, microstrip antennas, coplanar wave antennas, or other types of antennas suitable for transmission of RF signals. In some MIMO (multiple-input and multiple output) embodiments, antennas 405 are separated to take advantage of spatial diversity.

eNB 410 and UE 430 are operable to communicate with each other on a network, such as a wireless network. eNB 410 and UE 430 may be in communication with each other over a wireless communication channel 450, which has both a downlink path from eNB 410 to UE 430 and an uplink path from UE 430 to eNB 410.

As illustrated in FIG. 4, in some embodiments, eNB 410 may include a physical layer circuitry 412, a MAC (media access control) circuitry 414, a processor 416, a memory 418, and a hardware processing circuitry 420. A person skilled in the art will appreciate that other components not shown may be used in addition to the components shown to form a complete eNB.

In some embodiments, physical layer circuitry 412 includes a transceiver 413 for providing signals to and from UE 430. Transceiver 413 provides signals to and from UEs or other devices using one or more antennas 405. In some embodiments, MAC circuitry 414 controls access to the wireless medium. Memory 418 may be, or may include, a storage media/medium such as a magnetic storage media (e.g., magnetic tapes or magnetic disks), an optical storage media (e.g., optical discs), an electronic storage media (e.g., conventional hard disk drives, solid-state disk drives, or flash-memory-based storage media), or any tangible storage media or non-transitory storage media. Hardware processing circuitry 420 may comprise logic devices or circuitry to perform various operations. In some embodiments, processor 416 and memory 418 are arranged to perform the operations of hardware processing circuitry 420, such as operations described herein with reference to logic devices and circuitry within eNB 410 and/or hardware processing circuitry 420.

Accordingly, in some embodiments, eNB 410 may be a device comprising an application processor, a memory, one or more antenna ports, and an interface for allowing the application processor to communicate with another device.

As is also illustrated in FIG. 4, in some embodiments, UE 430 may include a physical layer circuitry 432, a MAC circuitry 434, a processor 436, a memory 438, a hardware processing circuitry 440, a wireless interface 442, and a display 444. A person skilled in the art would appreciate that other components not shown may be used in addition to the components shown to form a complete UE.

In some embodiments, physical layer circuitry 432 includes a transceiver 433 for providing signals to and from eNB 410 (as well as other eNBs). Transceiver 433 provides signals to and from eNBs or other devices using one or more antennas 425. In some embodiments, MAC circuitry 434 controls access to the wireless medium. Memory 438 may be, or may include, a storage media/medium such as a magnetic storage media (e.g., magnetic tapes or magnetic disks), an optical storage media (e.g., optical discs), an electronic storage media (e.g., conventional hard disk drives, solid-state disk drives, or flash-memory-based storage media), or any tangible storage media or non-transitory storage media. Wireless interface 442 may be arranged to allow the processor to communicate with another device. Display 444 may provide a visual and/or tactile display for a user to interact with UE 430, such as a touch-screen display. Hardware processing circuitry 440 may comprise logic devices or circuitry to perform various operations. In some embodiments, processor 436 and memory 438 may be arranged to perform the operations of hardware processing circuitry 440, such as operations described herein with reference to logic devices and circuitry within UE 430 and/or hardware processing circuitry 440.

Accordingly, in some embodiments, UE 430 may be a device comprising an application processor, a memory, one or more antennas, a wireless interface for allowing the application processor to communicate with another device, and a touch-screen display.

Elements of FIG. 4, and elements of other figures having the same names or reference numbers, can operate or function in the manner described herein with respect to any such figures (although the operation and function of such elements is not limited to such descriptions). For example, FIGS. 5-6 and 9-10 also depict embodiments of eNBs, hardware processing circuitry of eNBs, UEs, and/or hardware processing circuitry of UEs, and the embodiments described with respect to FIG. 4 and FIGS. 5-6 and 9-10 can operate or function in the manner described herein with respect to any of the figures.

In addition, although eNB 410 and UE 430 are each described as having several separate functional elements, one or more of the functional elements may be combined and may be implemented by combinations of software-configured elements and/or other hardware elements. In some embodiments of this disclosure, the functional elements can refer to one or more processes operating on one or more processing elements. Examples of software and/or hardware configured elements include Digital Signal Processors (DSPs), one or more microprocessors, DSPs, Field-Programmable Gate Arrays (FPGAs), Application Specific Integrated Circuits (ASICs), Radio-Frequency Integrated Circuits (RFICs), and so on.

FIG. 5 illustrates hardware processing circuitries for a UE for supporting DM-RS port assignment to users and control signaling to notify users of DM-RS port assignments, in accordance with some embodiments of the disclosure. With reference to FIG. 4, a UE may include various hardware processing circuitries discussed herein (such as hardware processing circuitry 500 of FIG. 5), which may in turn comprise logic devices and/or circuitry operable to perform various operations. For example, in FIG. 4, UE 430 (or various elements or components therein, such as hardware processing circuitry 440, or combinations of elements or components therein) may include part of, or all of, these hardware processing circuitries.

In some embodiments, one or more devices or circuitries within these hardware processing circuitries may be implemented by combinations of software-configured elements and/or other hardware elements. For example, processor 436 (and/or one or more other processors which UE 430 may comprise), memory 438, and/or other elements or components of UE 430 (which may include hardware processing circuitry 440) may be arranged to perform the operations of these hardware processing circuitries, such as operations described herein with reference to devices and circuitry within these hardware processing circuitries. In some embodiments, processor 436 (and/or one or more other processors which UE 430 may comprise) may be a baseband processor.

Returning to FIG. 5, an apparatus of UE 430 (or another UE or mobile handset), which may be operable to communicate with one or more eNBs on a wireless network, may comprise hardware processing circuitry 500. In some embodiments, hardware processing circuitry 500 may comprise one or more antenna ports 505 operable to provide various transmissions over a wireless communication channel (such as wireless communication channel 450). Antenna ports 505 may be coupled to one or more antennas 507 (which may be antennas 425). In some embodiments, hardware processing circuitry 500 may incorporate antennas 507, while in other embodiments, hardware processing circuitry 500 may merely be coupled to antennas 507.

Antenna ports 505 and antennas 507 may be operable to provide signals from a UE to a wireless communications channel and/or an eNB, and may be operable to provide signals from an eNB and/or a wireless communications channel to a UE. For example, antenna ports 505 and antennas 507 may be operable to provide transmissions from UE 430 to wireless communication channel 450 (and from there to eNB 410, or to another eNB). Similarly, antennas 507 and antenna ports 505 may be operable to provide transmissions from a wireless communication channel 450 (and beyond that, from eNB 410, or another eNB) to UE 430.

Hardware processing circuitry 500 may comprise various circuitries operable in accordance with the various embodiments discussed herein. With reference to FIG. 5, hardware processing circuitry 500 may comprise a first circuitry 510 and/or a second circuitry 520.

First circuitry 510 may be operable to process a first transmission carrying a DM-RS antenna port group indicator and a second transmission carrying an antenna port configuration indicator. Second circuitry 520 may be operable to select a DM-RS antenna port group comprising a set of antenna port configurations based upon the DM-RS antenna port group indicator. Second circuitry 520 may also be operable to select an antenna port configuration out of the set of antenna port configurations based upon the antenna port configuration indicator, the antenna port configuration comprising one or more DM-RS antenna ports (and/or indices of DM-RS antenna ports). First circuitry 510 may be operable to provide information regarding the DM-RS antenna port group indicator and/or the antenna port configuration indicator to second circuitry 520 via an interface 512. First circuitry 510 may be operable to process a third transmission carrying DM-RS in accordance with the selected antenna port configuration. Second circuitry 520 may be operable to provide information regarding the selected antenna port configuration to first circuitry 510 via an interface 522. Hardware processing circuitry 500 may additionally comprise an interface for receiving transmissions from a receiving circuitry (such as the first transmission, the second transmission, and the third transmission).

In some embodiments, the second transmission may be a DCI transmission. For some embodiments, the first transmission may be one of: a RRC transmission; a MAC transmission; or a DCI transmission. In some embodiments, the DM-RS antenna port group may be selected from at least a first DM-RS antenna port group and a second DM-RS antenna port group, and one or more DM-RS antenna ports of the first DM-RS antenna port group may overlap with one or more DM-RS antenna ports of the second DM-RS antenna port group. In some embodiments, the DM-RS antenna port group may be selected from at least a first DM-RS antenna port group and a second DM-RS antenna port group, and one or more DM-RS antenna ports of the first DM-RS antenna port group may not overlap with one or more DM-RS antenna ports of the second DM-RS antenna port group.

For some embodiments, selecting the DM-RS antenna port group may include identifying a transmission direction from one: a DL direction, an UL direction, or a Sidelink (SL) direction. In some embodiments, the transmission direction may be associated with one of a PDSCH transmission, or a PUSCH transmission. For some embodiments, establishing the DM-RS antenna port group may include identifying an associated TP. In some embodiments, the association with the TP may be based upon a CSI-RS configuration. For some embodiments, the DM-RS antenna port group indicator may be for MU-MIMO transmission. In some embodiments, the DM-RS antenna port group may be selected from at least a first DM-RS antenna port group and a second DM-RS antenna port group, and a number of DM-RS antenna ports for MU-MIMO transmission of the first DM-RS antenna port group may be different from a number of DM-RS antenna ports for MU-MIMO transmission of the second DM-RS group.

In some embodiments, first circuitry 510 and/or second circuitry 520 may be implemented as separate circuitries. In other embodiments, first circuitry 510 and/or second circuitry 520 may be combined and implemented together in a circuitry without altering the essence of the embodiments.

FIG. 6 illustrates hardware processing circuitries for an eNB for supporting DM-RS port assignment to users and control signaling to notify users of DM-RS port assignments, in accordance with some embodiments of the disclosure. With reference to FIG. 4, an eNB may include various hardware processing circuitries discussed herein (such as hardware processing circuitry 600 of FIG. 6), which may in turn comprise logic devices and/or circuitry operable to perform various operations. For example, in FIG. 4, eNB 410 (or various elements or components therein, such as hardware processing circuitry 420, or combinations of elements or components therein) may include part of, or all of, these hardware processing circuitries.

In some embodiments, one or more devices or circuitries within these hardware processing circuitries may be implemented by combinations of software-configured elements and/or other hardware elements. For example, processor 416 (and/or one or more other processors which eNB 410 may comprise), memory 418, and/or other elements or components of eNB 410 (which may include hardware processing circuitry 420) may be arranged to perform the operations of these hardware processing circuitries, such as operations described herein with reference to devices and circuitry within these hardware processing circuitries. In some embodiments, processor 416 (and/or one or more other processors which eNB 410 may comprise) may be a baseband processor.

Returning to FIG. 6, an apparatus of eNB 410 (or another eNB or base station), which may be operable to communicate with one or more UEs on a wireless network, may comprise hardware processing circuitry 600. In some embodiments, hardware processing circuitry 600 may comprise one or more antenna ports 605 operable to provide various transmissions over a wireless communication channel (such as wireless communication channel 450). Antenna ports 605 may be coupled to one or more antennas 607 (which may be antennas 405). In some embodiments, hardware processing circuitry 600 may incorporate antennas 607, while in other embodiments, hardware processing circuitry 600 may merely be coupled to antennas 607.

Antenna ports 605 and antennas 607 may be operable to provide signals from an eNB to a wireless communications channel and/or a UE, and may be operable to provide signals from a UE and/or a wireless communications channel to an eNB. For example, antenna ports 605 and antennas 607 may be operable to provide transmissions from eNB 410 to wireless communication channel 450 (and from there to UE 430, or to another UE). Similarly, antennas 607 and antenna ports 605 may be operable to provide transmissions from a wireless communication channel 450 (and beyond that, from UE 430, or another UE) to eNB 410.

Hardware processing circuitry 600 may comprise various circuitries operable in accordance with the various embodiments discussed herein. With reference to FIG. 6, hardware processing circuitry 600 may comprise a first circuitry 610 and/or a second circuitry 620.

First circuitry 610 may be operable to establish a DM-RS antenna port group for the UE and a corresponding DM-RS antenna port group indicator, the DM-RS antenna port group comprising a set of antenna port configurations. First circuitry 610 may also be operable to establish an antenna port configuration and a corresponding antenna port configuration indicator, the antenna port configuration being one of the set of antenna port configurations, and the antenna port configuration comprising one or more DM-RS antenna ports (and/or indices of DM-RS antenna ports). Second circuitry 620 may be operable to generate a first transmission carrying the DM-RS antenna port group indicator and a second transmission carrying the antenna port configuration indicator. Second circuitry 620 may also be operable to generate a third transmission carrying DM-RS corresponding with the selected antenna port configuration. First circuitry 610 may be operable to provide information regarding the DM-RS antenna port group indicator, the antenna port configuration indicator, and/or the selected antenna port configuration. Hardware processing circuitry 600 may also comprise an interface for sending transmissions to a transmission circuitry.

In some embodiments, the second transmission may be a DCI transmission. For some embodiments, the first transmission may be one of: an RRC transmission; a MAC transmission; or a DCI transmission. In some embodiments, the DM-RS antenna port group may be selected from at least a first DM-RS antenna port group for the UE and a second DM-RS antenna port group for the UE, and one or more DM-RS antenna ports of the first DM-RS antenna port group may overlap with one or more DM-RS antenna ports of the second DM-RS antenna port group. In some embodiments, the DM-RS antenna port group may be selected from at least a first DM-RS antenna port group for the UE and a second DM-RS antenna port group for the UE, and one or more DM-RS antenna ports of the first DM-RS antenna port group may not overlap with one or more DM-RS antenna ports of the second DM-RS antenna port group.

For some embodiments, establishing the DM-RS antenna port group may include identifying a transmission direction from one: a DL direction, a UL direction, or an SL direction. In some embodiments, the transmission direction may be associated with one of a PDSCH transmission, or a PUSCH transmission. For some embodiments, establishing the DM-RS antenna port group may include identifying an associated TP. In some embodiments, the association with the TP may be based upon a CSI-RS configuration. For some embodiments, the DM-RS antenna port group indicator may be for MU-MIMO transmission. In some embodiments, the DM-RS antenna port group may be selected from at least a first DM-RS antenna port group and a second DM-RS antenna port group, and a number of DM-RS antenna ports for MU-MIMO transmission of the first DM-RS antenna port group may be different from a number of DM-RS antenna ports for MU-MIMO transmission of the second DM-RS group.

In some embodiments, first circuitry 610 and/or second circuitry 620 may be implemented as separate circuitries. In other embodiments, first circuitry 610 and/or second circuitry 620 may be combined and implemented together in a circuitry without altering the essence of the embodiments.

FIG. 7 illustrates methods for a UE for supporting DM-RS port assignment to users and control signaling to notify users of DM-RS port assignments, in accordance with some embodiments of the disclosure. With reference to FIG. 4, methods that may relate to UE 430 and hardware processing circuitry 440 are discussed herein. Although the actions in method 700 of FIG. 7 are shown in a particular order, the order of the actions can be modified. Thus, the illustrated embodiments can be performed in a different order, and some actions may be performed in parallel. Some of the actions and/or operations listed in FIG. 7 are optional in accordance with certain embodiments. The numbering of the actions presented is for the sake of clarity and is not intended to prescribe an order of operations in which the various actions must occur. Additionally, operations from the various flows may be utilized in a variety of combinations.

Moreover, in some embodiments, machine readable storage media may have executable instructions that, when executed, cause UE 430 and/or hardware processing circuitry 440 to perform an operation comprising the methods of FIG. 7. Such machine readable storage media may include any of a variety of storage media, like magnetic storage media (e.g., magnetic tapes or magnetic disks), optical storage media (e.g., optical discs), electronic storage media (e.g., conventional hard disk drives, solid-state disk drives, or flash-memory-based storage media), or any other tangible storage media or non-transitory storage media.

In some embodiments, an apparatus may comprise means for performing various actions and/or operations of the methods of FIG. 7.

Returning to FIG. 7, various methods may be in accordance with the various embodiments discussed herein. A method 700 may comprise a processing 710, a selecting 715, a selecting 720, and a processing 725.

In processing 710, a first transmission carrying a DM-RS antenna port group indicator and a second transmission carrying an antenna port configuration indicator may be processed. In selecting 715, a DM-RS antenna port group comprising a set of antenna port configurations may be selected based upon the DM-RS antenna port group indicator. In selecting 720, an antenna port configuration may be selected out of the set of antenna port configurations based upon the antenna port configuration indicator, the antenna port configuration comprising one or more DM-RS antenna ports (and/or indices of DM-RS antenna ports). In processing 725, a third transmission carrying DM-RS may be processed in accordance with the selected antenna port configuration.

In some embodiments, the second transmission may be a DCI transmission. For some embodiments, the first transmission may be one of: a RRC transmission; a MAC transmission; or a DCI transmission. In some embodiments, the DM-RS antenna port group may be selected from at least a first DM-RS antenna port group and a second DM-RS antenna port group, and one or more DM-RS antenna ports of the first DM-RS antenna port group may overlap with one or more DM-RS antenna ports of the second DM-RS antenna port group. In some embodiments, the DM-RS antenna port group may be selected from at least a first DM-RS antenna port group and a second DM-RS antenna port group, and one or more DM-RS antenna ports of the first DM-RS antenna port group may not overlap with one or more DM-RS antenna ports of the second DM-RS antenna port group.

For some embodiments, selecting the DM-RS antenna port group may include identifying a transmission direction from one: a DL direction, an UL direction, or a SL direction. In some embodiments, the transmission direction may be associated with one of a PDSCH transmission, or a PUSCH transmission. For some embodiments, establishing the DM-RS antenna port group may include identifying an associated TP. In some embodiments, the association with the TP may be based upon a CSI-RS configuration. For some embodiments, the DM-RS antenna port group indicator may be for MU-MIMO transmission. In some embodiments, the DM-RS antenna port group may be selected from at least a first DM-RS antenna port group and a second DM-RS antenna port group, and a number of DM-RS antenna ports for MU-MIMO transmission of the first DM-RS antenna port group may be different from a number of DM-RS antenna ports for MU-MIMO transmission of the second DM-RS group.

FIG. 8 illustrates methods for an eNB for supporting DM-RS port assignment to users and control signaling to notify users of DM-RS port assignments, in accordance with some embodiments of the disclosure. With reference to FIG. 4, various methods that may relate to eNB 410 and hardware processing circuitry 420 are discussed herein. Although the actions in method 800 of FIG. 8 are shown in a particular order, the order of the actions can be modified. Thus, the illustrated embodiments can be performed in a different order, and some actions may be performed in parallel. Some of the actions and/or operations listed in FIG. 8 are optional in accordance with certain embodiments. The numbering of the actions presented is for the sake of clarity and is not intended to prescribe an order of operations in which the various actions must occur. Additionally, operations from the various flows may be utilized in a variety of combinations.

Moreover, in some embodiments, machine readable storage media may have executable instructions that, when executed, cause eNB 410 and/or hardware processing circuitry 420 to perform an operation comprising the methods of FIG. 8. Such machine readable storage media may include any of a variety of storage media, like magnetic storage media (e.g., magnetic tapes or magnetic disks), optical storage media (e.g., optical discs), electronic storage media (e.g., conventional hard disk drives, solid-state disk drives, or flash-memory-based storage media), or any other tangible storage media or non-transitory storage media.

In some embodiments, an apparatus may comprise means for performing various actions and/or operations of the methods of FIG. 8.

Returning to FIG. 8, various methods may be in accordance with the various embodiments discussed herein. A method 800 may comprise an establishing 810, an establishing 815, a generating 820, and a generating 825.

In establishing 810, a DM-RS antenna port group for the UE and a corresponding DM-RS antenna port group indicator may be established, the DM-RS antenna port group comprising a set of antenna port configurations. In establishing 815, an antenna port configuration and a corresponding antenna port configuration indicator may be established, the antenna port configuration being one of the set of antenna port configurations, and the antenna port configuration comprising one or more DM-RS antenna ports (and/or indices of DM-RS antenna ports). In generating 820, a first transmission carrying the DM-RS antenna port group indicator and a second transmission carrying the antenna port configuration indicator may be generated. In generating 825, a third transmission carrying DM-RS corresponding with the selected antenna port configuration may be generated.

In some embodiments, the second transmission may be a DCI transmission. For some embodiments, the first transmission may be one of: an RRC transmission; a MAC transmission; or a DCI transmission. In some embodiments, the DM-RS antenna port group may be selected from at least a first DM-RS antenna port group for the UE and a second DM-RS antenna port group for the UE, and one or more DM-RS antenna ports of the first DM-RS antenna port group may overlap with one or more DM-RS antenna ports of the second DM-RS antenna port group. In some embodiments, the DM-RS antenna port group may be selected from at least a first DM-RS antenna port group for the UE and a second DM-RS antenna port group for the UE, and one or more DM-RS antenna ports of the first DM-RS antenna port group may not overlap with one or more DM-RS antenna ports of the second DM-RS antenna port group.

For some embodiments, establishing the DM-RS antenna port group may include identifying a transmission direction from one: a DL direction, a UL direction, or an SL direction. In some embodiments, the transmission direction may be associated with one of a PDSCH transmission, or a PUSCH transmission. For some embodiments, establishing the DM-RS antenna port group may include identifying an associated TP. In some embodiments, the association with the TP may be based upon a CSI-RS configuration. For some embodiments, the DM-RS antenna port group indicator may be for MU-MIMO transmission. In some embodiments, the DM-RS antenna port group may be selected from at least a first DM-RS antenna port group and a second DM-RS antenna port group, and a number of DM-RS antenna ports for MU-MIMO transmission of the first DM-RS antenna port group may be different from a number of DM-RS antenna ports for MU-MIMO transmission of the second DM-RS group.

FIG. 9 illustrates example components of a device, in accordance with some embodiments of the disclosure. In some embodiments, the device 900 may include application circuitry 902, baseband circuitry 904, Radio Frequency (RF) circuitry 906, front-end module (FEM) circuitry 908, one or more antennas 910, and power management circuitry (PMC) 912 coupled together at least as shown. The components of the illustrated device 900 may be included in a UE or a RAN node. In some embodiments, the device 900 may include less elements (e.g., a RAN node may not utilize application circuitry 902, and instead include a processor/controller to process IP data received from an EPC). In some embodiments, the device 900 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, and so on). The processors may be coupled with or may include memory/storage and may be configured to execute instructions stored in the memory/storage to enable various applications or operating systems to run on the device 900. In some embodiments, processors of application circuitry 902 may process IP data packets received from an EPC.

The baseband circuitry 904 may include circuitry such as, but not limited to, one or more single-core or multi-core processors. The baseband circuitry 904 may include one or more baseband processors or control logic to process baseband signals received from a receive signal path of the RF circuitry 906 and to generate baseband signals for a transmit signal path of the RF circuitry 906. Baseband processing circuitry 904 may interface with the application circuitry 902 for generation and processing of the baseband signals and for controlling operations of the RF circuitry 906. For example, in some embodiments, the baseband circuitry 904 may include a third generation (3G) baseband processor 904A, a fourth generation (4G) baseband processor 904B, a fifth generation (5G) baseband processor 904C, or other baseband processor(s) 904D for other existing generations, generations in development or to be developed in the future (e.g., second generation (2G), sixth generation (6G), and so on). The baseband circuitry 904 (e.g., one or more of baseband processors 904A-D) may handle various radio control functions that enable communication with one or more radio networks via the RF circuitry 906. In other embodiments, some or all of the functionality of baseband processors 904A-D may be included in modules stored in the memory 904G and executed via a Central Processing Unit (CPU) 904E. The radio control functions may include, but are not limited to, signal modulation/demodulation, encoding/decoding, radio frequency shifting, and so on. In some embodiments, modulation/demodulation circuitry of the baseband circuitry 904 may include Fast-Fourier Transform (FFT), precoding, or constellation mapping/demapping functionality. In some embodiments, encoding/decoding circuitry of the baseband circuitry 904 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include one or more audio digital signal processor(s) (DSP) 904F. The audio DSP(s) 904F may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 904 is configured to support radio communications of more than one wireless protocol may be referred to as multi-mode baseband circuitry.

RF circuitry 906 may enable communication with wireless networks using modulated electromagnetic radiation through a non-solid medium. In various embodiments, the RF circuitry 906 may include switches, filters, amplifiers, and so on to facilitate the communication with the wireless network. RF circuitry 906 may include a receive signal path which may include circuitry to down-convert RF signals received from the FEM circuitry 908 and provide baseband signals to the baseband circuitry 904. RF circuitry 906 may also include a transmit signal path which may include circuitry to up-convert baseband signals provided by the baseband circuitry 904 and provide RF output signals to the FEM circuitry 908 for transmission.

In some embodiments, the receive signal path of the RF circuitry 906 may include mixer circuitry 906A, amplifier circuitry 906B and filter circuitry 906C. In some embodiments, the transmit signal path of the RF circuitry 906 may include filter circuitry 906C and mixer circuitry 906A. RF circuitry 906 may also include synthesizer circuitry 906D for synthesizing a frequency for use by the mixer circuitry 906A of the receive signal path and the transmit signal path. In some embodiments, the mixer circuitry 906A of the receive signal path may be configured to down-convert RF signals received from the FEM circuitry 908 based on the synthesized frequency provided by synthesizer circuitry 906D. The amplifier circuitry 906B may be configured to amplify the down-converted signals and the filter circuitry 906C may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, mixer circuitry 906A of the receive signal path may comprise passive mixers, although the scope of the embodiments is not limited in this respect.

In some embodiments, the mixer circuitry 906A of the transmit signal path may be configured to up-convert input baseband signals based on the synthesized frequency provided by the synthesizer circuitry 906D to generate RF output signals for the FEM circuitry 908. The baseband signals may be provided by the baseband circuitry 904 and may be filtered by filter circuitry 906C.

In some embodiments, the mixer circuitry 906A of the receive signal path and the mixer circuitry 906A of the transmit signal path may include two or more mixers and may be arranged for quadrature downconversion and upconversion, respectively. In some embodiments, the mixer circuitry 906A of the receive signal path and the mixer circuitry 906A of the transmit signal path may include two or more mixers and may be arranged for image rejection (e.g., Hartley image rejection). In some embodiments, the mixer circuitry 906A of the receive signal path and the mixer circuitry 906A may be arranged for direct downconversion and direct upconversion, respectively. In some embodiments, the mixer circuitry 906A of the receive signal path and the mixer circuitry 906A of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 906 may include analog-to-digital converter (ADC) and digital-to-analog converter (DAC) circuitry and the baseband circuitry 904 may include a digital baseband interface to communicate with the RF circuitry 906.

In some dual-mode embodiments, a separate radio IC circuitry may be provided for processing signals for each spectrum, although the scope of the embodiments is not limited in this respect.

In some embodiments, the synthesizer circuitry 906D may be a fractional-N synthesizer or a fractional N/N+1 synthesizer, although the scope of the embodiments is not limited in this respect as other types of frequency synthesizers may be suitable. For example, synthesizer circuitry 906D may be a delta-sigma synthesizer, a frequency multiplier, or a synthesizer comprising a phase-locked loop with a frequency divider.

The synthesizer circuitry 906D may be configured to synthesize an output frequency for use by the mixer circuitry 906A of the RF circuitry 906 based on a frequency input and a divider control input. In some embodiments, the synthesizer circuitry 906D may be a fractional N/N+1 synthesizer.

In some embodiments, frequency input may be provided by a voltage controlled oscillator (VCO), although that is not a requirement. Divider control input may be provided by either the baseband circuitry 904 or the applications processor 902 depending on the desired output frequency. In some embodiments, a divider control input (e.g., N) may be determined from a look-up table based on a channel indicated by the applications processor 902.

Synthesizer circuitry 906D of the RF circuitry 906 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 906D may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 906 may include an IQ/polar converter.

FEM circuitry 908 may include a receive signal path which may include circuitry configured to operate on RF signals received from one or more antennas 910, amplify the received signals and provide the amplified versions of the received signals to the RF circuitry 906 for further processing. FEM circuitry 908 may also include a transmit signal path which may include circuitry configured to amplify signals for transmission provided by the RF circuitry 906 for transmission by one or more of the one or more antennas 910. In various embodiments, the amplification through the transmit or receive signal paths may be done solely in the RF circuitry 906, solely in the FEM 908, or in both the RF circuitry 906 and the FEM 908.

In some embodiments, the FEM circuitry 908 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 906). The transmit signal path of the FEM circuitry 908 may include a power amplifier (PA) to amplify input RF signals (e.g., provided by RF circuitry 906), and one or more filters to generate RF signals for subsequent transmission (e.g., by one or more of the one or more antennas 910).

In some embodiments, the PMC 912 may manage power provided to the baseband circuitry 904. In particular, the PMC 912 may control power-source selection, voltage scaling, battery charging, or DC-to-DC conversion. The PMC 912 may often be included when the device 900 is capable of being powered by a battery, for example, when the device is included in a UE. The PMC 912 may increase the power conversion efficiency while providing desirable implementation size and heat dissipation characteristics.

While FIG. 9 shows the PMC 912 coupled only with the baseband circuitry 904. However, in other embodiments, the PMC 912 may be additionally or alternatively coupled with, and perform similar power management operations for, other components such as, but not limited to, application circuitry 902, RF circuitry 906, or FEM 908.

In some embodiments, the PMC 912 may control, or otherwise be part of, various power saving mechanisms of the device 900. For example, if the device 900 is in an RRC_Connected state, where it is still connected to the RAN node as it expects to receive traffic shortly, then it may enter a state known as Discontinuous Reception Mode (DRX) after a period of inactivity. During this state, the device 900 may power down for brief intervals of time and thus save power.

If there is no data traffic activity for an extended period of time, then the device 900 may transition off to an RRC Idle state, where it disconnects from the network and does not perform operations such as channel quality feedback, handover, and so on. The device 900 goes into a very low power state and it performs paging where again it periodically wakes up to listen to the network and then powers down again. The device 900 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 902 and processors of the baseband circuitry 904 may be used to execute elements of one or more instances of a protocol stack. For example, processors of the baseband circuitry 904, alone or in combination, may be used execute Layer 3, Layer 2, or Layer 1 functionality, while processors of the application circuitry 904 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 10 illustrates example interfaces of baseband circuitry, in accordance with some embodiments of the disclosure. As discussed above, the baseband circuitry 904 of FIG. 9 may comprise processors 904A-904E and a memory 904G utilized by said processors. Each of the processors 904A-904E may include a memory interface, 1004A-1004E, respectively, to send/receive data to/from the memory 904G.

The baseband circuitry 904 may further include one or more interfaces to communicatively couple to other circuitries/devices, such as a memory interface 1012 (e.g., an interface to send/receive data to/from memory external to the baseband circuitry 904), an application circuitry interface 1014 (e.g., an interface to send/receive data to/from the application circuitry 902 of FIG. 9), an RF circuitry interface 1016 (e.g., an interface to send/receive data to/from RF circuitry 906 of FIG. 9), a wireless hardware connectivity interface 1018 (e.g., an interface to send/receive data to/from Near Field Communication (NFC) components, Bluetooth® components (e.g., Bluetooth® Low Energy), Wi-Fi® components, and other communication components), and a power management interface 1020 (e.g., an interface to send/receive power or control signals to/from the PMC 912.

It is pointed out that elements of any of the Figures herein having the same reference numbers and/or names as elements of any other Figure herein may, in various embodiments, operate or function in a manner similar those elements of the other Figure (without being limited to operating or functioning in such a manner).

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

Example 1 provides an apparatus of a User Equipment (UE) operable to communicate with a Next-Generation Node-B (gNB) on a wireless network, comprising: one or more processors to: process a first transmission carrying a Demodulation Reference Signal (DM-RS) antenna port group indicator and a second transmission carrying an antenna port configuration indicator; select a DM-RS antenna port group comprising a set of antenna port configurations based upon the DM-RS antenna port group indicator; select an antenna port configuration out of the set of antenna port configurations based upon the antenna port configuration indicator, the antenna port configuration comprising one or more DM-RS antenna ports; and process a third transmission carrying DM-RS in accordance with the selected antenna port configuration, and an interface for receiving transmissions from a receiving circuitry.

In example 2, the apparatus of example 1, wherein the second transmission is a Downlink Control Information (DCI) transmission.

In example 3, the apparatus of any of examples 1 through 2, wherein the first transmission is one of: a Radio Resource Control (RRC) transmission; a Media Access Control (MAC) transmission; or a Downlink Control Information (DCI) transmission.

In example 4, the apparatus of any of examples 1 through 3, wherein the DM-RS antenna port group is selected from at least a first DM-RS antenna port group and a second DM-RS antenna port group; and wherein one or more DM-RS antenna ports of the first DM-RS antenna port group overlap with one or more DM-RS antenna ports of the second DM-RS antenna port group.

In example 5, the apparatus of any of examples 1 through 3, wherein the DM-RS antenna port group is selected from at least a first DM-RS antenna port group and a second DM-RS antenna port group; and wherein one or more DM-RS antenna ports of the first DM-RS antenna port group do not overlap with one or more DM-RS antenna ports of the second DM-RS antenna port group.

In example 6, the apparatus of any of examples 1 through 5, wherein selecting the DM-RS antenna port group includes identifying a transmission direction from one: a Downlink (DL) direction, an Uplink (UL) direction, or a Sidelink (SL) direction.

In example 7, the apparatus of example 6, wherein the transmission direction is associated with one of a Physical Downlink Shared Channel (PDSCH) transmission, or a Physical Uplink Shared Channel (PUSCH) transmission.

In example 8, the apparatus of any of examples 1 through 7, wherein establishing the DM-RS antenna port group includes identifying an associated Transmission Point (TP).

In example 9, the apparatus of example 8, wherein the association with the TP is based upon a Channel State Information Reference Signal (CSI-RS) configuration.

In example 10, the apparatus of any of examples 1 through 9, wherein the DM-RS antenna port group indicator is for Multi-User Multiple-Input Multiple-Output (MU-MIMO) transmission.

In example 11, the apparatus of any of examples 1 through 10, wherein the DM-RS antenna port group is selected from at least a first DM-RS antenna port group and a second DM-RS antenna port group; and wherein a number of DM-RS antenna ports for MU-MIMO transmission of the first DM-RS antenna port group is different from a number of DM-RS antenna ports for MU-MIMO transmission of the second DM-RS group.

Example 12 provides a User Equipment (UE) device comprising an application processor, a memory, one or more antennas, a wireless interface for allowing the application processor to communicate with another device, and a touch-screen display, the UE device including the apparatus of any of examples 1 through 11.

Example 13 provides machine readable storage media having machine executable instructions that, when executed, cause one or more processors of a User Equipment (UE) operable to communicate with a Next-Generation Node-B (gNB) on a wireless network to perform an operation comprising: process a first transmission carrying a Demodulation Reference Signal (DM-RS) antenna port group indicator and a second transmission carrying an antenna port configuration indicator; select a DM-RS antenna port group comprising a set of antenna port configurations based upon the DM-RS antenna port group indicator; select an antenna port configuration out of the set of antenna port configurations based upon the antenna port configuration indicator, the antenna port configuration comprising one or more DM-RS antenna ports; and process a third transmission carrying DM-RS in accordance with the selected antenna port configuration.

In example 14, the machine readable storage media of example 13, wherein the second transmission is a Downlink Control Information (DCI) transmission.

In example 15, the machine readable storage media of any of examples 13 through 14, wherein the first transmission is one of: a Radio Resource Control (RRC) transmission; a Media Access Control (MAC) transmission; or a Downlink Control Information (DCI) transmission.

In example 16, the machine readable storage media of any of examples 13 through 15, wherein the DM-RS antenna port group is selected from at least a first DM-RS antenna port group and a second DM-RS antenna port group; and wherein one or more DM-RS antenna ports of the first DM-RS antenna port group overlap with one or more DM-RS antenna ports of the second DM-RS antenna port group.

In example 17, the machine readable storage media of any of examples 13 through 15, wherein the DM-RS antenna port group is selected from at least a first DM-RS antenna port group and a second DM-RS antenna port group; and wherein one or more DM-RS antenna ports of the first DM-RS antenna port group do not overlap with one or more DM-RS antenna ports of the second DM-RS antenna port group.

In example 18, the machine readable storage media of any of examples 13 through 17, wherein selecting the DM-RS antenna port group includes identifying a transmission direction from one: a Downlink (DL) direction, an Uplink (UL) direction, or a Sidelink (SL) direction.

In example 19, the machine readable storage media of example 18, wherein the transmission direction is associated with one of a Physical Downlink Shared Channel (PDSCH) transmission, or a Physical Uplink Shared Channel (PUSCH) transmission.

In example 20, the machine readable storage media of any of examples 13 through 19, wherein establishing the DM-RS antenna port group includes identifying an associated Transmission Point (TP).

In example 21, the machine readable storage media of example 20, wherein the association with the TP is based upon a Channel State Information Reference Signal (CSI-RS) configuration.

In example 22, the machine readable storage media of any of examples 13 through 21, wherein the DM-RS antenna port group indicator is for Multi-User Multiple-Input Multiple-Output (MU-MIMO) transmission.

In example 23, the machine readable storage media of any of examples 13 through 22, wherein the DM-RS antenna port group is selected from at least a first DM-RS antenna port group and a second DM-RS antenna port group; and wherein a number of DM-RS antenna ports for MU-MIMO transmission of the first DM-RS antenna port group is different from a number of DM-RS antenna ports for MU-MIMO transmission of the second DM-RS group.

Example 24 provides an apparatus of a Next-Generation Node-B (gNB) operable to communicate with a User Equipment (UE) on a wireless network, comprising: one or more processors to: establish a Demodulation Reference Signal (DM-RS) antenna port group for the UE and a corresponding DM-RS antenna port group indicator, the DM-RS antenna port group comprising a set of antenna port configurations; establish an antenna port configuration and a corresponding antenna port configuration indicator, the antenna port configuration being one of the set of antenna port configurations, and the antenna port configuration comprising one or more DM-RS antenna ports; generate a first transmission carrying the DM-RS antenna port group indicator and a second transmission carrying the antenna port configuration indicator; and generate a third transmission carrying DM-RS corresponding with the selected antenna port configuration, and an interface for sending transmissions to a transmission circuitry.

In example 25, the apparatus of example 24, wherein the second transmission is a Downlink Control Information (DCI) transmission.

In example 26, the apparatus of any of examples 24 through 25, wherein the first transmission is one of: a Radio Resource Control (RRC) transmission; a Media Access Control (MAC) transmission; or a Downlink Control Information (DCI) transmission.

In example 27, the apparatus of any of examples 24 through 26, wherein the DM-RS antenna port group is selected from at least a first DM-RS antenna port group for the UE and a second DM-RS antenna port group for the UE; and wherein one or more DM-RS antenna ports of the first DM-RS antenna port group overlap with one or more DM-RS antenna ports of the second DM-RS antenna port group.

In example 28, the apparatus of any of examples 24 through 26, wherein the DM-RS antenna port group is selected from at least a first DM-RS antenna port group for the UE and a second DM-RS antenna port group for the UE; and wherein one or more DM-RS antenna ports of the first DM-RS antenna port group do not overlap with one or more DM-RS antenna ports of the second DM-RS antenna port group.

In example 29, the apparatus of any of examples 24 through 28, wherein establishing the DM-RS antenna port group includes identifying a transmission direction from one: a Downlink (DL) direction, an Uplink (UL) direction, or a Sidelink (SL) direction.

In example 30, the apparatus of example 29, wherein the transmission direction is associated with one of a Physical Downlink Shared Channel (PDSCH) transmission, or a Physical Uplink Shared Channel (PUSCH) transmission.

In example 31, the apparatus of any of examples 24 through 30, wherein establishing the DM-RS antenna port group includes identifying an associated Transmission Point (TP).

In example 32, the apparatus of example 31, wherein the association with the TP is based upon a Channel State Information Reference Signal (CSI-RS) configuration.

In example 33, the apparatus of any of examples 24 through 32, wherein the DM-RS antenna port group indicator is for Multi-User Multiple-Input Multiple-Output (MU-MIMO) transmission.

In example 34, the apparatus of any of examples 24 through 33, wherein the DM-RS antenna port group is selected from at least a first DM-RS antenna port group and a second DM-RS antenna port group; and wherein a number of DM-RS antenna ports for MU-MIMO transmission of the first DM-RS antenna port group is different from a number of DM-RS antenna ports for MU-MIMO transmission of the second DM-RS group.

Example 35 provides a Next-Generation Node-B (gNB) device comprising an application processor, a memory, one or more antenna ports, and an interface for allowing the application processor to communicate with another device, the gNB device including the apparatus of any of examples 24 through 34.

Example 36 provides machine readable storage media having machine executable instructions that, when executed, cause one or more processors of a Next-Generation Node-B (gNB) operable to communicate with a User Equipment (UE) on a wireless network to perform an operation comprising: establish a Demodulation Reference Signal (DM-RS) antenna port group for the UE and a corresponding DM-RS antenna port group indicator, the DM-RS antenna port group comprising a set of antenna port configurations; establish an antenna port configuration and a corresponding antenna port configuration indicator, the antenna port configuration being one of the set of antenna port configurations, and the antenna port configuration comprising one or more DM-RS antenna ports; generate a first transmission carrying the DM-RS antenna port group indicator and a second transmission carrying the antenna port configuration indicator; and generate a third transmission carrying DM-RS corresponding with the selected antenna port configuration.

In example 37, the machine readable storage media of example 36, wherein the second transmission is a Downlink Control Information (DCI) transmission.

In example 38, the machine readable storage media of any of examples 36 through 37, wherein the first transmission is one of: a Radio Resource Control (RRC) transmission; a Media Access Control (MAC) transmission; or a Downlink Control Information (DCI) transmission.

In example 39, the machine readable storage media of any of examples 36 through 38, wherein the DM-RS antenna port group is selected from at least a first DM-RS antenna port group for the UE and a second DM-RS antenna port group for the UE; and wherein one or more DM-RS antenna ports of the first DM-RS antenna port group overlap with one or more DM-RS antenna ports of the second DM-RS antenna port group.

In example 40, the machine readable storage media of any of examples 36 through 38, wherein the DM-RS antenna port group is selected from at least a first DM-RS antenna port group for the UE and a second DM-RS antenna port group for the UE; and wherein one or more DM-RS antenna ports of the first DM-RS antenna port group do not overlap with one or more DM-RS antenna ports of the second DM-RS antenna port group.

In example 41, the machine readable storage media of any of examples 36 through 40, wherein establishing the DM-RS antenna port group includes identifying a transmission direction from one: a Downlink (DL) direction, an Uplink (UL) direction, or a Sidelink (SL) direction.

In example 42, the machine readable storage media of example 41, wherein the transmission direction is associated with one of a Physical Downlink Shared Channel (PDSCH) transmission, or a Physical Uplink Shared Channel (PUSCH) transmission.

In example 43, the machine readable storage media of any of examples 36 through 42, wherein establishing the DM-RS antenna port group includes identifying an associated Transmission Point (TP).

In example 44, the machine readable storage media of example 43, wherein the association with the TP is based upon a Channel State Information Reference Signal (CSI-RS) configuration.

In example 45, the machine readable storage media of any of examples 36 through 44, wherein the DM-RS antenna port group indicator is for Multi-User Multiple-Input Multiple-Output (MU-MIMO) transmission.

In example 46, the machine readable storage media of any of examples 36 through 45, wherein the DM-RS antenna port group is selected from at least a first DM-RS antenna port group and a second DM-RS antenna port group; and wherein a number of DM-RS antenna ports for MU-MIMO transmission of the first DM-RS antenna port group is different from a number of DM-RS antenna ports for MU-MIMO transmission of the second DM-RS group.

In example 47, the apparatus of any of examples 1 through 11, and 24 through 34, wherein the one or more processors comprise a baseband processor.

In example 48, the apparatus of any of examples 1 through 11, and 24 through 34, comprising a memory for storing instructions, the memory being coupled to the one or more processors.

In example 49, the apparatus of any of examples 1 through 11, and 24 through 34, comprising a transceiver circuitry for at least one of: generating transmissions, encoding transmissions, processing transmissions, or decoding transmissions.

In example 50, the apparatus of any of examples 1 through 11, and 24 through 34, comprising a transceiver circuitry for generating transmissions and processing transmissions. An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1-24. (canceled)

25. An apparatus of a User Equipment (UE) operable to communicate with a Next-Generation Node-B (gNB) on a wireless network, comprising:
one or more processors to:
process a first transmission carrying a Demodulation Reference Signal (DM-RS) antenna port group indicator and a second transmission carrying an antenna port configuration indicator;
select a DM-RS antenna port group comprising a set of antenna port configurations based upon the DM-RS antenna port group indicator;
select an antenna port configuration out of the set of antenna port configurations based upon the antenna port configuration indicator, the antenna port configuration comprising one or more DM-RS antenna ports; and
process a third transmission carrying DM-RS in accordance with the selected antenna port configuration, and
an interface for receiving transmissions from a receiving circuitry.

26. The apparatus of claim 25,
wherein the second transmission is a Downlink Control Information (DCI) transmission.

27. The apparatus of claim 25,
wherein the first transmission is one of: a Radio Resource Control (RRC) transmission; a Media Access Control (MAC) transmission; or a Downlink Control Information (DCI) transmission.

28. The apparatus of claim 25,
wherein the DM-RS antenna port group is selected from at least a first DM-RS antenna port group and a second DM-RS antenna port group; and
wherein one or more DM-RS antenna ports of the first DM-RS antenna port group overlap with one or more DM-RS antenna ports of the second DM-RS antenna port group.

29. The apparatus of claim 25,
wherein the DM-RS antenna port group is selected from at least a first DM-RS antenna port group and a second DM-RS antenna port group; and
wherein one or more DM-RS antenna ports of the first DM-RS antenna port group do not overlap with one or more DM-RS antenna ports of the second DM-RS antenna port group.

30. The apparatus of claim 25,
wherein selecting the DM-RS antenna port group includes identifying a transmission direction from one: a Downlink (DL) direction, an Uplink (UL) direction, or a Sidelink (SL) direction.

31. Machine readable storage media having machine executable instructions that, when executed, cause one or more processors of a User Equipment (UE) operable to communicate with a Next-Generation Node-B (gNB) on a wireless network to perform an operation comprising:
process a first transmission carrying a Demodulation Reference Signal (DM-RS) antenna port group indicator and a second transmission carrying an antenna port configuration indicator;
select a DM-RS antenna port group comprising a set of antenna port configurations based upon the DM-RS antenna port group indicator;
select an antenna port configuration out of the set of antenna port configurations based upon the antenna port configuration indicator, the antenna port configuration comprising one or more DM-RS antenna ports; and
process a third transmission carrying DM-RS in accordance with the selected antenna port configuration.

32. The machine readable storage media of claim 31,
wherein the second transmission is a Downlink Control Information (DCI) transmission.

33. The machine readable storage media of claim 31,
wherein the first transmission is one of: a Radio Resource Control (RRC) transmission; a Media Access Control (MAC) transmission; or a Downlink Control Information (DCI) transmission.

34. The machine readable storage media of claim 31,
wherein the DM-RS antenna port group is selected from at least a first DM-RS antenna port group and a second DM-RS antenna port group; and
wherein one or more DM-RS antenna ports of the first DM-RS antenna port group overlap with one or more DM-RS antenna ports of the second DM-RS antenna port group.

35. The machine readable storage media of claim 31,
wherein the DM-RS antenna port group is selected from at least a first DM-RS antenna port group and a second DM-RS antenna port group; and
wherein one or more DM-RS antenna ports of the first DM-RS antenna port group do not overlap with one or more DM-RS antenna ports of the second DM-RS antenna port group.

36. The machine readable storage media of claim 31,
wherein selecting the DM-RS antenna port group includes identifying a transmission direction from one: a Downlink (DL) direction, an Uplink (UL) direction, or a Sidelink (SL) direction.

37. An apparatus of a Next-Generation Node-B (gNB) operable to communicate with a User Equipment (UE) on a wireless network, comprising:
one or more processors to:
establish a Demodulation Reference Signal (DM-RS) antenna port group for the UE and a corresponding DM-RS antenna port group indicator, the DM-RS antenna port group comprising a set of antenna port configurations;
establish an antenna port configuration and a corresponding antenna port configuration indicator, the antenna port configuration being one of the set of antenna port configurations, and the antenna port configuration comprising one or more DM-RS antenna ports;
generate a first transmission carrying the DM-RS antenna port group indicator and a second transmission carrying the antenna port configuration indicator; and
generate a third transmission carrying DM-RS corresponding with the selected antenna port configuration, and
an interface for sending transmissions to a transmission circuitry.

38. The apparatus of claim 37,
wherein the second transmission is a Downlink Control Information (DCI) transmission.

39. The apparatus of claim 37,
wherein the first transmission is one of: a Radio Resource Control (RRC) transmission; a Media Access Control (MAC) transmission; or a Downlink Control Information (DCI) transmission.

40. The apparatus of claim 37,
wherein the DM-RS antenna port group is selected from at least a first DM-RS antenna port group for the UE and a second DM-RS antenna port group for the UE; and
wherein one or more DM-RS antenna ports of the first DM-RS antenna port group overlap with one or more DM-RS antenna ports of the second DM-RS antenna port group.

41. The apparatus of claim 37,
wherein the DM-RS antenna port group is selected from at least a first DM-RS antenna port group for the UE and a second DM-RS antenna port group for the UE; and
wherein one or more DM-RS antenna ports of the first DM-RS antenna port group do not overlap with one or more DM-RS antenna ports of the second DM-RS antenna port group.

42. The apparatus of claim 37,
wherein establishing the DM-RS antenna port group includes identifying a transmission direction from one: a Downlink (DL) direction, an Uplink (UL) direction, or a Sidelink (SL) direction.

43. Machine readable storage media having machine executable instructions that, when executed, cause one or more processors of a Next-Generation Node-B (gNB) operable to communicate with a User Equipment (UE) on a wireless network to perform an operation comprising:
establish a Demodulation Reference Signal (DM-RS) antenna port group for the UE and a corresponding DM-RS antenna port group indicator, the DM-RS antenna port group comprising a set of antenna port configurations;
establish an antenna port configuration and a corresponding antenna port configuration indicator, the antenna port configuration being one of the set of antenna port configurations, and the antenna port configuration comprising one or more DM-RS antenna ports;
generate a first transmission carrying the DM-RS antenna port group indicator and a second transmission carrying the antenna port configuration indicator; and
generate a third transmission carrying DM-RS corresponding with the selected antenna port configuration.

44. The machine readable storage media of claim 43,
wherein the second transmission is a Downlink Control Information (DCI) transmission.

45. The machine readable storage media of claim 43,
wherein the first transmission is one of: a Radio Resource Control (RRC) transmission; a Media Access Control (MAC) transmission; or a Downlink Control Information (DCI) transmission.

46. The machine readable storage media of claim 43,
wherein the DM-RS antenna port group is selected from at least a first DM-RS antenna port group for the UE and a second DM-RS antenna port group for the UE; and
wherein one or more DM-RS antenna ports of the first DM-RS antenna port group overlap with one or more DM-RS antenna ports of the second DM-RS antenna port group.

47. The machine readable storage media of claim 43,
wherein the DM-RS antenna port group is selected from at least a first DM-RS antenna port group for the UE and a second DM-RS antenna port group for the UE; and
wherein one or more DM-RS antenna ports of the first DM-RS antenna port group do not overlap with one or more DM-RS antenna ports of the second DM-RS antenna port group.

48. The machine readable storage media of claim 43,
wherein establishing the DM-RS antenna port group includes identifying a transmission direction from one: a Downlink (DL) direction, an Uplink (UL) direction, or a Sidelink (SL) direction.
